(19) United States
(12) Patent Application Publication
(10) Pub. No.: US 2021/0049139 A1
(43) Pub. Date: Feb. 18, 2021

(54) MULTI-BOOK ALLOCATIONS WITH SNAPSHOT VERIFICATION

(71) Applicant: Sage Intacct, Inc., San Jose, CA (US)

(72) Inventors: Katie McCloskey, Georgetown, TX (US); Chandrashekhar Punji, Bangalore (IN); Sophie Im, San Jose, CA (US); Sharanabasavaraj Sunkad, Bangalore (IN)

(21) Appl. No.: 16/991,570

(22) Filed: Aug. 12, 2020

Related U.S. Application Data
(60) Provisional application No. 62/885,480, filed on Aug. 12, 2019.

(51) Int. Cl. G06F 16/21; G06F 16/248; G06F 16/242; G06F 11/14

(52) U.S. Cl. CPC G06F 16/219; G06F 16/248; G06F 11/1461; G06F 11/1448; G06F 16/244

(57) ABSTRACT

Mechanisms are provided for specifying, viewing and verifying allocations, including a snapshot look-back function to provide views of previously specified justifications and support for particular allocations. The look-back function can provide visibility as to how specific allocation numbers were generated. Allocations can be viewed at different historical points in time, to provide insight as to when and why a particular allocation was specified. These views can also show calculation parameters and results. A user-defined book can facilitate allocation workflow in such a way that users can easily view allocations both before and after the fact. Users can configure the system to maintain the option of before/after views on a going-forward basis. An allocation journal entry can be displayed, including a link to additional information, such as source, basis, and/or applied dynamic percentage calculations.

### CROSS-REFERENCE TO RELATED APPLICATION

The present application claims the benefit of U.S. Provisional Application Ser. No. 62/885,480 for “Multi-Book Allocations with Snapshot Verification” (Attorney Docket No. INT020-PROV), filed Aug. 12, 2019, which is incorporated by reference herein in its entirety.

### TECHNICAL FIELD

The present document relates to techniques for specifying, viewing, and verifying accounting allocations.

### BACKGROUND

In accounting software, allocations are a mechanism for shifting monetary funds from one set of accounts to another. Allocations are commonly applied to accounts that may initially include pooled costs (such as overhead, insurance, and the like) that then must be divided up among different, more specific accounts (such as different operations or departments of a business).

However, in many situations, it can be difficult to determine justifications as to why items and/or funds were allocated in a particular way, in particular after the fact. Conventional systems do not provide a way to automatically provide insights as to an allocation, particularly after the allocation has taken effect.

### SUMMARY

In various embodiments, the system and method described herein can record and provide justifications as to why items and/or funds were allocated in a particular way. The system and method can thereby provide useful insights as to allocations, both before and after the allocation takes effect. Such insights allow for auditing and/or look-back, so as to provide tools for understanding the allocation methodology and thereby encourage consistency and accuracy in performing allocations.

In at least one embodiment, the system and method described herein provide mechanisms for specifying, viewing and verifying allocations, including a snapshot look-back function to provide views of previously specified justifications and support for particular allocations. The look-back function can provide visibility as to how specific allocation numbers were generated.

In at least one embodiment, the system and method provide mechanisms for viewing allocations at different historical points in time, to provide insight as to when and why a particular allocation was specified. These views can also show calculation parameters and results.

In at least one embodiment, the system and method provide a user-defined book to allow allocation workflow in such a way that users can easily view allocations both before and after the fact. In addition, users can configure the system to maintain the option of before/after views on a going-forward basis. In at least one embodiment, an allocation journal entry can be displayed, including a link to additional information, such as source, basis, and/or applied dynamic percentage calculations.

By providing such functionality, the described system removes the need to create shadow accounts or other types of alternate accounts for allocation purposes and/or to reverse out the allocation impact at the beginning of each period. The system also provides easy access to an audit trail to allow views of justifications and support of applied allocations; such access can be provided via a snapshot view of allocation parameters, including source and basis amounts that can be associated with created journal entries as appropriate.

In various embodiments, the described system provides functionality to perform allocations based on account balances. As described in more detail herein, the system can dynamically gather source balances and can also dynamically generate the calculation basis. Once an allocation has been configured, it can be applied multiple times. In addition, the system allows a user to easily trace through the results of an allocation, thus enabling look-back functionality.

Further details and variations are described herein.

### BRIEF DESCRIPTION OF THE DRAWINGS

The accompanying drawings, together with the description, illustrate several embodiments. One skilled in the art will recognize that the particular embodiments illustrated in the drawings are merely exemplary, and are not intended to limit scope.

FIG. 1 is a block diagram depicting a hardware architecture for implementing the techniques described herein according to one embodiment.

FIG. 2 is a block diagram depicting a hardware architecture for implementing the techniques described herein in a client/server environment, according to one embodiment.

FIG. 3 is a block diagram depicting an overall conceptual architecture of a system for performing multi-book allocations with snapshot verification according to one embodiment.

FIG. 4A is a flow diagram depicting an overall dynamic allocation method according to one embodiment.

FIG. 4B is a flow diagram depicting additional details of a dynamic allocation method according to one embodiment.

FIG. 5 is a screen shot depicting an example of a set of configuration options for processing and viewing outcome impacts, according to one embodiment.

FIG. 6 is a screen shot depicting an example of an allocation expenditure analysis, according to one embodiment.

FIG. 7 is a screen shot depicting an on-screen display of allocated expenses across departments, according to one embodiment, showing a comparison of two allocation methods with the pre-allocation amounts.

FIG. 8 is a screen shot depicting an on-screen display of snapshot verification via drill-down functionality, according to one embodiment.

FIG. 9 is a flow diagram depicting a conceptual overview of allocations according to one embodiment.

FIGS. 10A and 10B are screen shots depicting examples of allocation logs presented in a hierarchical view, according to one embodiment.

FIG. 11A is a screen shot depicting an example of a Statement of Functional Expenses report that displays the balances of different accounts before and after an allocation was run, according to one embodiment.

FIG. 11B is a screen shot depicting an example of a general ledger report that displays details concerning a value affected by an allocation, according to one embodiment.

FIGS. 11C through 11E are screen shots depicting an example of a scrollable allocation information report according to one embodiment.

FIG. 12 is a screen shot depicting an example of a view of journal entries associated with an allocation, according to one embodiment.

FIG. 13 depicts an example of a spreadsheet document containing source pool information, according to one embodiment.

FIG. 14 depicts an example of a spreadsheet document containing basis information, according to one embodiment.

FIG. 15 is a screen shot depicting an example of a rationale section of an allocation information screen, according to one embodiment.

FIG. 16A is a screen shot depicting an example of a dimensions treatment section of an allocation information screen, according to one embodiment.

FIG. 16B is a screen shot depicting another example of a dimensions treatment section of an allocation information screen, wherein allocations can be performed across entities, according to one embodiment.

FIG. 17 is a screen shot depicting an example of a source pool section that allows the user to define where the system will dynamically find the amount to use for the allocation, according to one embodiment.

FIG. 18 is a screen shot depicting an example of a basis section of an allocation information screen, according to one embodiment.

FIG. 19A is a screen shot depicting an example of a target entry section of an allocation information screen, according to one embodiment.

FIG. 19B is a screen shot depicting another example of a target entry section of an allocation information screen, including an option to flag target lines as billable, according to one embodiment.

FIG. 20 is a screen shot depicting an example of a generate allocation screen, according to one embodiment.

FIG. 21 is a screen shot depicting an example of a statement of functional expenses run from the financial report center, according to one embodiment.

FIG. 22 is a screen shot depicting an example of a screen for reviewing journal entries generated by an allocation, according to one embodiment.

FIG. 23 depicts an example of a spreadsheet document that contains source pool information at the time an allocation was run, according to one embodiment.

FIG. 24 depicts an example of a spreadsheet document that contains basis information at the time an allocation was run, according to one embodiment.

FIG. 25 is a screen shot depicting an example of a dynamic split calculation table for an allocation, according to one embodiment.

FIG. 26 is a screen shot depicting an example of an allocation information screen, according to one embodiment.

FIG. 27 is a screen shot depicting an example of a screen for configuring an allocation group, according to one embodiment.

### DETAILED DESCRIPTION OF THE EMBODIMENTS

The systems and methods set forth herein may be applied to many contexts in which it can be useful to provide multi-book allocations with snapshot verification. For illustrative purposes, the description herein is set forth with respect to a method and system of providing multi-book allocations with snapshot verification as implemented in an accounting software package. One of skill in the art will recognize that the systems and methods described herein may be implemented in a wide variety of other contexts. In addition, the particular hardware arrangement depicted and described herein is a simplified example for illustrative purposes.

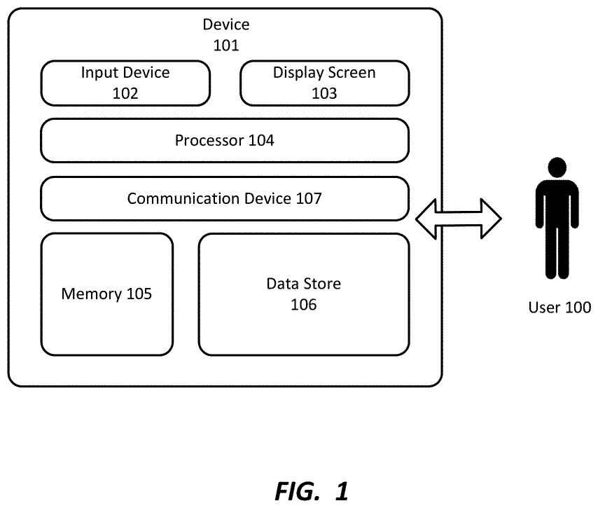

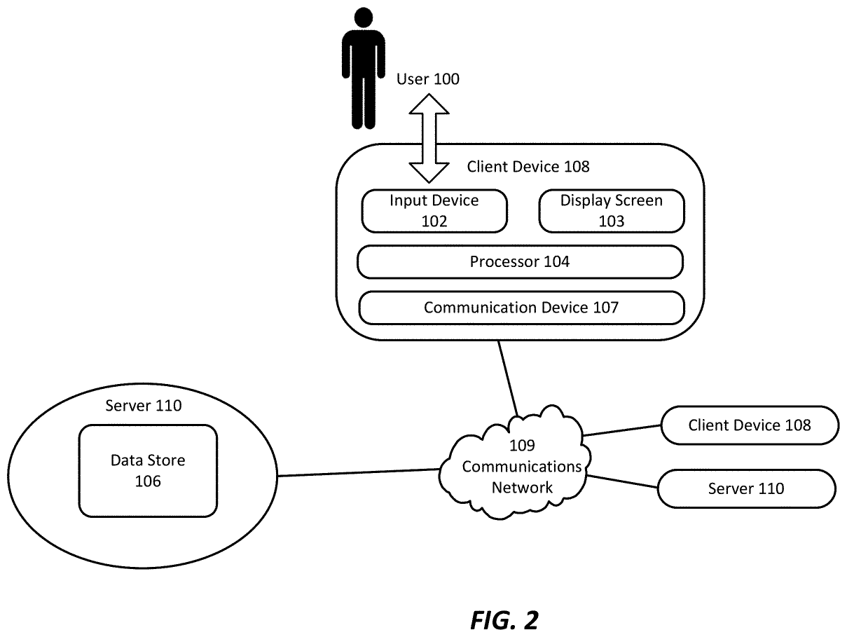

In some embodiments, one or more components, as shown and described below in connection with FIGS. 1 and 2, may be used to implement the system and method described herein. Such components may be implemented in a cloud computing-based client/server architecture, using, for example, Amazon Web Services, an on-demand cloud computing platform available from Amazon.com, Inc. of Seattle, Wash. Therefore, for illustrative purposes, the system and method are described herein in the context of such an architecture. One skilled in the art will recognize, however, that the system and method can be implemented using other architectures, such as for example a stand-alone computing device rather than a client/server architecture.

Further, the functions and/or method steps set forth below may be carried out by software running on one or more of the device 101, client device(s) 108, server 110, and/or other components. This software may optionally be multi-function software that is used to retrieve, store, manipulate, and/or otherwise use data stored in data storage devices such as data store 106, and/or to carry out one or more other functions.

In this application, a “user”, such as user 100 referenced herein, is an individual, enterprise, or other group, which may optionally include one or more users. A “data store”, such as data store 106 referenced below, is any device capable of digital data storage, including any known hardware for nonvolatile and/or volatile data storage. A collection of data stores 106 may form a “data storage system” that can be accessed by multiple users. A “computing device”, such as device 101 and/or client device(s) 108, is any device capable of digital data processing. A “server”, such as server 110, is a computing device that provides data storage, either via a local data store, or via connection to a remote data store. A “client device”, such as client device 108, is an electronic device that communicates with a server, provides output to a user, and accepts input from a user.

### System Architecture

According to various embodiments, the system and method can be implemented on any electronic device or set of interconnected electronic devices, each equipped to receive, store, and present information. Each electronic device may be, for example, a server, desktop computer, laptop computer, smartphone, tablet computer, and/or the like. As described herein, some devices used in connection with the system described herein are designated as client devices, which are generally operated by end users. Other devices are designated as servers, which generally conduct back-end operations and communicate with client devices (and/or with other servers) via a communications network such as the Internet. In at least one embodiment, the methods described herein can be implemented in a cloud computing environment using techniques that are known to those of skill in the art.

In addition, one skilled in the art will recognize that the techniques described herein can be implemented in other contexts, and indeed in any suitable device, set of devices, or system capable of interfacing with existing enterprise data storage systems. Accordingly, the following description is intended to illustrate various embodiments by way of example, rather than to limit scope.

Referring now to FIG. 1, there is shown a block diagram depicting a hardware architecture for practicing the described system, according to one embodiment. Such an architecture can be used, for example, for implementing the techniques of the system in a computer or other device 101. Device 101 may be any electronic device.

In at least one embodiment, device 101 includes a number of hardware components well-known to those skilled in the art. Input device 102 can be any element that receives input from user 100, including, for example, a keyboard, mouse, stylus, touch-sensitive screen (touchscreen), touchpad, trackball, accelerometer, microphone, or the like. Input can be provided via any suitable mode, including for example, one or more of: pointing, tapping, typing, dragging, and/or speech. In at least one embodiment, input device 102 can be omitted or functionally combined with one or more other components.

Data store 106 can be any magnetic, optical, or electronic storage device for data in digital form; examples include flash memory, magnetic hard drive, CD-ROM, DVD-ROM, or the like. In at least one embodiment, data store 106 stores information that can be utilized and/or displayed according to the techniques described below. Data store 106 may be implemented in a database or using any other suitable arrangement. In another embodiment, data store 106 can be stored elsewhere, and data from data store 106 can be retrieved by device 101 when needed for processing and/or presentation to user 100. Data store 106 may store one or more data sets, which may be used for a variety of purposes and may include a wide variety of files, metadata, and/or other data.

In at least one embodiment, data store 106 may store accounting transaction data and/or other data that can be used in providing multi-book allocations with snapshot verification. In at least one embodiment, such data can be stored at another location, remote from device 101, and device 101 can access such data over a network, via any suitable communications protocol.

In at least one embodiment, data store 106 may be organized in a file system, using well known storage architectures and data structures, such as relational databases. Examples include Oracle, MySQL, and PostgreSQL. Appropriate indexing can be provided to associate data elements in data store 106 with each other. In at least one embodiment, data store 106 may be implemented using cloud-based storage architectures such as NetApp (available from NetApp, Inc. of Sunnyvale, Calif.) and/or Google Drive (available from Google, Inc. of Mountain View, Calif.).

Data store 106 can be local or remote with respect to the other components of device 101. In at least one embodiment, device 101 is configured to retrieve data from a remote data storage device when needed. Such communication between device 101 and other components can take place wirelessly, by Ethernet connection, via a computing network such as the Internet, via a cellular network, or by any other appropriate communication systems.

In at least one embodiment, data store 106 is detachable in the form of a CD-ROM, DVD, flash drive, USB hard drive, or the like. Information can be entered from a source outside of device 101 into a data store 106 that is detachable, and later displayed after the data store 106 is connected to device 101. In another embodiment, data store 106 is fixed within device 101.

In at least one embodiment, data store 106 may be organized into one or more well-ordered data sets, with one or more data entries in each set. Data store 106, however, can have any suitable structure. Accordingly, the particular organization of data store 106 need not resemble the form in which information from data store 106 is displayed to user 100. In at least one embodiment, an identifying label is also stored along with each data entry, to be displayed along with each data entry.

Display screen 103 can be any element that displays information such as text and/or graphical elements. In particular, display screen 103 may display a user interface for presenting data concerning allocations, and/or for prompting the user to accept or reject such allocations. In at least one embodiment where only some of the desired output is presented at a time, a dynamic control, such as a scrolling mechanism, may be available via input device 102 to change which information is currently displayed, and/or to alter the manner in which the information is displayed.

Processor 104 can be a conventional microprocessor for performing operations on data under the direction of software, according to well-known techniques. Memory 105 can be random-access memory, having a structure and architecture as are known in the art, for use by processor 104 in the course of running software.

A communication device 107 may communicate with other computing devices through the use of any known wired and/or wireless protocol(s). For example, communication device 107 may be a network interface card (“NIC”) capable of Ethernet communications and/or a wireless networking card capable of communicating wirelessly over any of the 802.11 standards. Communication device 107 may be capable of transmitting and/or receiving signals to transfer data and/or initiate various processes within and/or outside device 101.

Referring now to FIG. 2, there is shown a block diagram depicting a hardware architecture in a client/server environment, according to one embodiment. Such an implementation may use a “black box” approach, whereby data storage and processing are done completely independently from user input/output. An example of such a client/server environment is a web-based implementation, wherein client device 108 runs a browser that provides a user interface for interacting with web pages and/or other web-based resources from server 110. Items from data store 106 can be presented as part of such web pages and/or other web-based resources, using known protocols and languages such as Hypertext Markup Language (HTML), Java, JavaScript, and the like.

Client device 108 can be any electronic device incorporating input device 102 and/or display screen 103, such as a desktop computer, laptop computer, personal digital assistant (PDA), cellular telephone, smartphone, music player, handheld computer, tablet computer, kiosk, game system, wearable device, or the like. Any suitable type of communications network 109, such as the Internet, can be used as the mechanism for transmitting data between client device 108 and server 110, according to any suitable protocols and techniques. In addition to the Internet, other examples include cellular telephone networks, EDGE, 3G, 4G, 5G, long term evolution (LTE), Session Initiation Protocol (SIP), Short Message Peer-to-Peer protocol (SMPP), SS7, Wi-Fi, Bluetooth, ZigBee, Hypertext Transfer Protocol (HTTP), Secure Hypertext Transfer Protocol (SHTTP), Transmission Control Protocol/Internet Protocol (TCP/IP), and/or the like, and/or any combination thereof. In at least one embodiment, client device 108 transmits requests for data via communications network 109, and receives responses from server 110 containing the requested data. Such requests may be sent via HTTP as remote procedure calls or the like.

In one implementation, server 110 is responsible for data storage and processing, and incorporates data store 106. Server 110 may include additional components as needed for retrieving data from data store 106 in response to requests from client device 108.

As also set forth in FIG. 1, data store 106 may be organized into one or more well-ordered data sets, with one or more data entries in each set. Data store 106, however, can have any suitable structure, and may store data according to any organization system known in the information storage arts, such as databases and other suitable data storage structures. As in FIG. 1, data store 106 may store accounting transaction data and/or other data that can be used in providing multi-book allocations with snapshot verification; alternatively, such data can be stored elsewhere (such as at another server) and retrieved as needed.

In addition to or in the alternative to the foregoing, data may also be stored in a data store 106 present in client device 108. In some embodiments, such data may include elements distributed between server 110 and client device 108 and/or other computing devices in order to facilitate secure and/or effective communication between these computing devices.

As also set forth in FIG. 1, display screen 103 can be any element that displays information such as text and/or graphical elements. Various user interface elements, dynamic controls, and/or the like may be used in connection with display screen 103.

As also set forth in FIG. 1, processor 104 can be a conventional microprocessor for use in an electronic device to perform operations on data under the direction of software, according to well-known techniques. Memory 105 can be random-access memory, having a structure and architecture as are known in the art, for use by processor 104 in the course of running software. A communication device 107 may communicate with other computing devices through the use of any known wired and/or wireless protocol(s), as also set forth in the description of FIG. 1.

In one embodiment, some or all of the system can be implemented as software written in any suitable computer programming language, whether in a standalone or client/server architecture. Alternatively, it may be implemented and/or embedded in hardware.

Notably, multiple servers 110 and/or multiple client devices 108 may be networked together, and each may have a structure similar to those of client device 108 and server 110 that are illustrated in FIG. 2. The data structures and/or computing instructions used in the performance of methods described herein may be distributed among any number of client devices 108 and/or servers 110. As used herein, “system” may refer to any of the components, or any collection of components, from FIGS. 1 and/or 2, and may include additional components not specifically described in connection with FIGS. 1 and 2.

In some embodiments, data within data store 106 may be distributed among multiple physical servers. Thus, data store 106 may represent one or more physical storage locations, which may communicate with each other via the communications network and/or one or more other networks (not shown). In addition, server 110 as depicted in FIG. 2 may represent one or more physical servers, which may communicate with each other via communications network 109 and/or one or more other networks (not shown).

In one embodiment, some or all components of the system can be implemented in software written in any suitable computer programming language, whether in a standalone or client/server architecture. Alternatively, some or all components may be implemented and/or embedded in hardware.

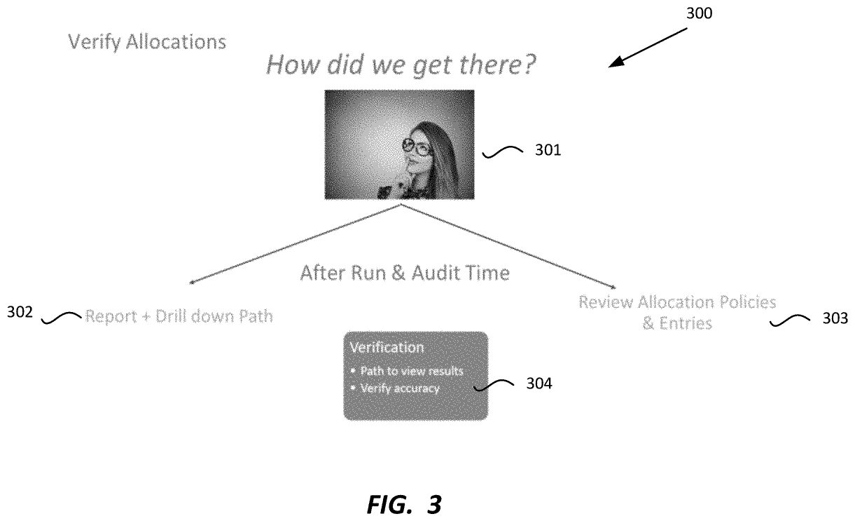

Referring now to FIG. 3, there is shown an overall conceptual architecture of a system 300 for performing multi-book allocations with snapshot verification according to one embodiment.

As depicted in FIG. 3, system 300 provides mechanisms for verifying previously specified allocations, essentially responding to query 301 which asks, “How did we get there?” In at least one embodiment, system 300 allows such information to be obtained after run-time, by providing a report and drilldown path 302 that allows visibility into previously specified allocations. In addition, system 300 can provide path 303 that facilitates review of allocation policies and entries. Verification functionality 304 provides a path to view results and to verify accuracy of the presented data. In at least one embodiment, each of the components and functional elements shown in FIG. 3 can be implemented as software modules running on a hardware architecture such as that shown in FIG. 1 or 2.

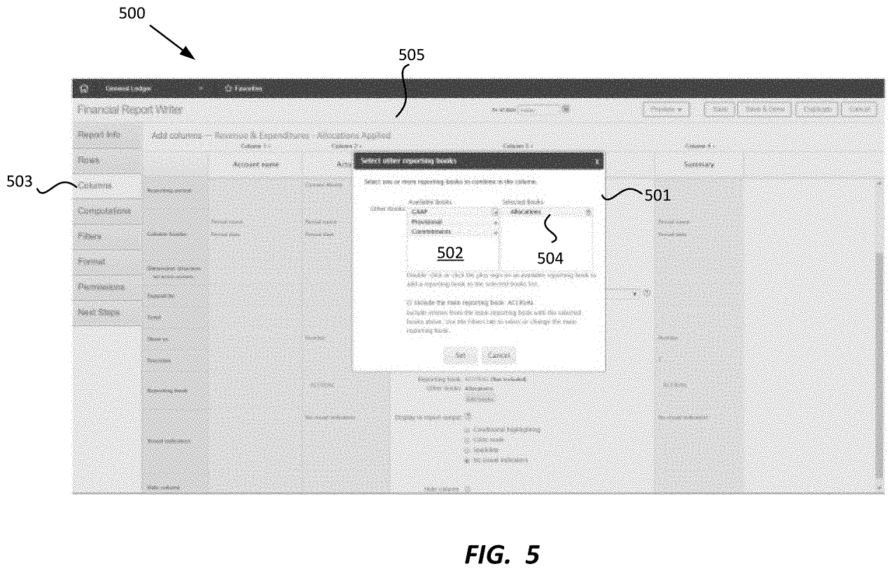

Referring now to FIG. 5, there is shown a screen shot depicting an example 500 of a set of configuration options for processing and viewing outcome impacts, according to one embodiment. Tab 503 provides access to screen 505 for adding and configuring columns for which allocations may be applied. Reporting books selection pane 501 allows user 100 to select from a list of available books 502 to combine in a particular column; selected books appear in list 504.

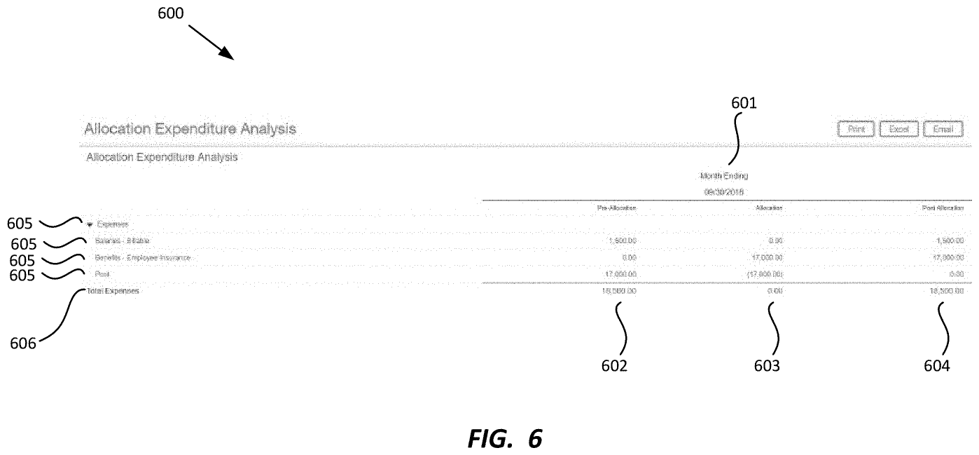

Referring now to FIG. 6, there is shown a screen shot depicting an example 600 of an allocation expenditure analysis, according to one embodiment. Allocations are shown for an identified time period 601, which in this example is the month ending Sep. 30, 2018. The expenditure analysis is shown for various categories 605, along with a row 606 for total expenses. For each row, column 602 depicts pre-allocation amounts, column 603 depicts the amount of the allocation, and column 604 depicts post-allocation amounts. FIG. 6 illustrates how the system can report with or without the allocation impacts. Such reporting can be used, for example, to evaluate how direct costs vs. indirect costs can be managed.

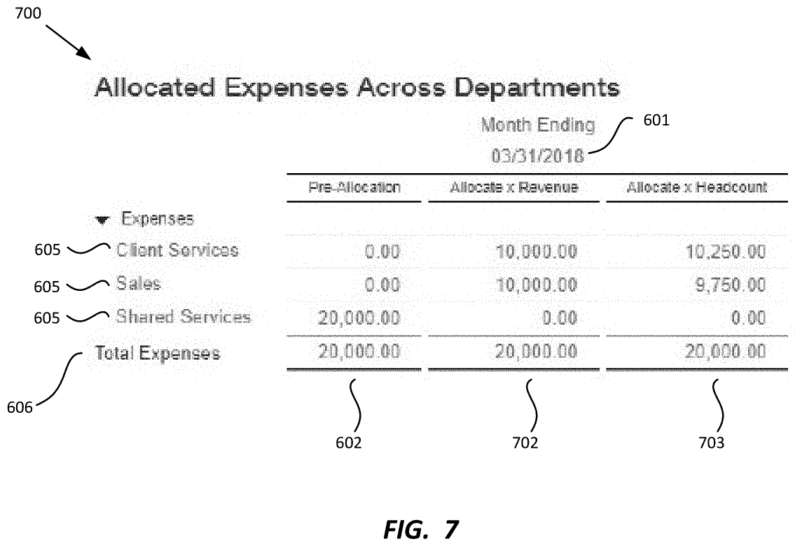

Referring now to FIG. 7, there is shown a screen shot depicting an example 700 of an on-screen display of allocated expenses across departments, according to one embodiment, showing a comparison of two allocation methods with the pre-allocation amounts. Allocations are shown for an identified time period 601, which in this example is the month ending Mar. 31, 2018. Allocated expenses are shown for various categories 605, along with a row 606 for total expenses. For each row, column 602 depicts pre-allocation amounts, column 702 depicts an allocation by revenue, and column 703 depicts an allocation by headcount. The display shown in FIG. 7 thus provides the ability to easily compare allocation outcomes using different acceptable basis parameters, allowing user 100 to decide which method is most useful, accurate, and/or favorable.

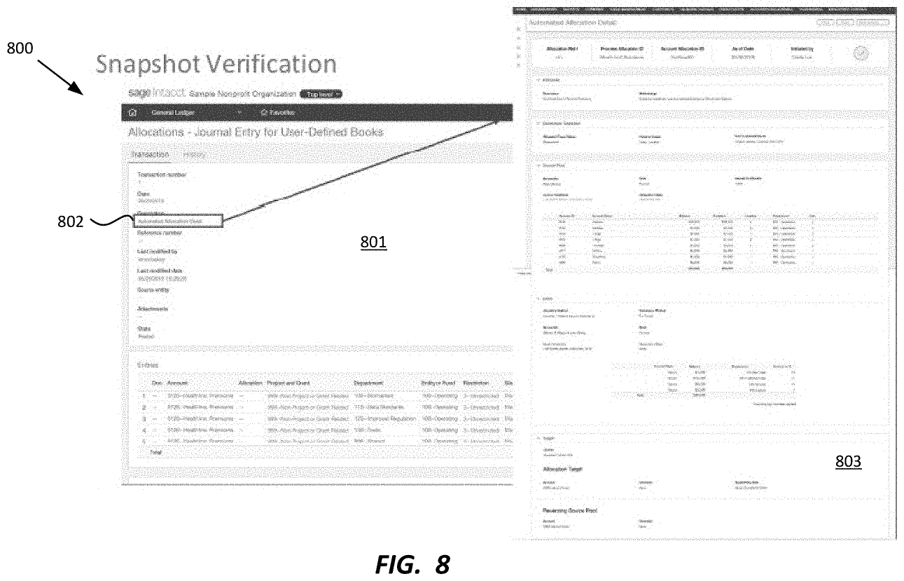

Referring now to FIG. 8, there is shown a screen shot depicting an example 800 of an on-screen display of snapshot verification via drill-down functionality, according to one embodiment. Window 801 depicts a previously specified allocation as a journal entry for user-defined books. User 100 can click on Automated Allocation Detail 802 within window 801 to activate pane 803, which displays justification and support for the previously specified allocation. In at least one embodiment, the system-generated journal entry that came from the allocation process contains a link to the underlying assumptions used to calculate it along with the data as it existed at the time of calculation. This alleviates any question of how or why and allocated amount came about.

### Dynamic Allocations Overview

According to various embodiments, the system and method described herein enable dynamic allocations, including functionality designed to dynamically gather source balances and distribute them across dimensions, according to a user-defined basis of calculation. User 100 can use allocation definition templates to repeatedly generate allocations without having to redefine the calculations every time.

Allocating revenues and costs helps an organization gain a better understanding of performance for departments, projects, and more. In addition, in at least one embodiment, the system can handle asset and liability allocations for investment allocations, pre-paid expenses, and/or the like.

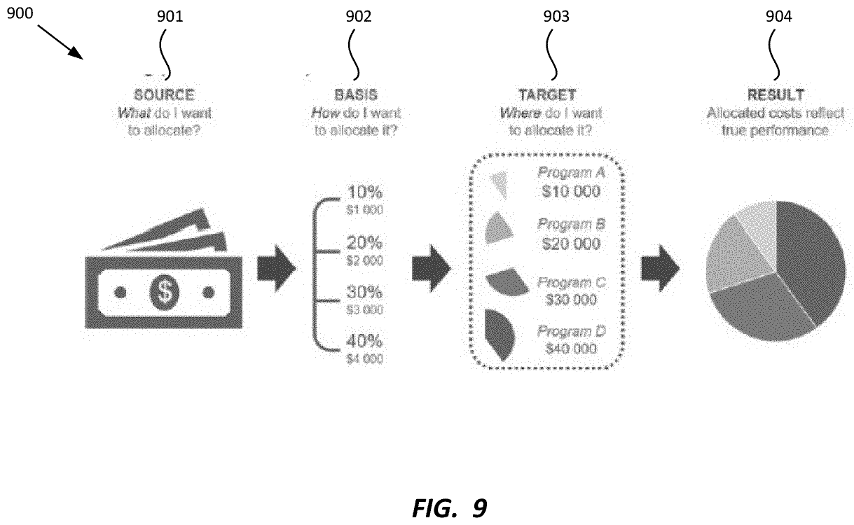

Referring now to FIG. 9, there is shown a flow diagram 900 depicting a conceptual overview of allocations. Source 901 represents an amount of funds to be allocated, which may belong to an account, category, subcategory, department, or the like. Basis 902 represents a manner in which funds from source 901 are to be allocated. Target 903 specified destination accounts, categories, programs, subcategories, and/or the like, for the allocated funds. In at least one embodiment, such allocations may be performed automatically; alternatively, they may be performed manually. Result 904 indicates how the allocated costs or amounts reflect performance of a company, department, region, product, project, division, or the like.

In at least one embodiment, the techniques described herein allow for snapshot verification of previous multi-book allocations, so as to streamline the process depicted in FIG. 9, and/or to provide user 100 with insight as to how and why a particular allocation was applied.

In at least one embodiment, the techniques described herein provide a native allocation solution that enables automated allocation calculation tasks for routinely shifting costs or sharing revenues among departments, groups, projects, and/or the like.

According to various embodiments, the described method and system provide dynamic allocation functionality to automatically pull source balances and distribute them across dimensions, according to a particular calculation method that is set as basis 902. In at least one embodiment, an allocation template can be configured so as to enable routinely generated allocations without requiring user 100 to redefine the calculations every time. This capability helps organizations that need more than generally provided core accounting transactional allocations, as well as those businesses that may require time-consuming periodic or complex allocations.

In at least one embodiment, the described dynamic allocation functionality offers easy setup, including parameters and allocation methodology, routine processing, and a click-through history to make it easy to look back at how allocations have been derived and applied. For example, the following functionality can be provided:
Ability to allocate revenues, expenses, assets, and/or liabilities (such as, for example, intra-entity revenue and expense allocations);
Dynamic source balance pull; and
Dynamic basis calculation.

Auditors analyze allocations and often require proof that a consistent, reasonable methodology was used to produce allocation entries. The described method and system capture allocation parameters at the time of processing, and attach a snapshot of both the setup and the results to the posted entry, thereby providing an audit trail for every allocation. In at least one embodiment, the described method and system also provide drill-down visibility to source and basis amounts associated with the allocation.

In at least one embodiment, allocations are associated with a particular time period. As described in more detail below, the dynamic allocation definition includes both source pool and basis sections, each of which can specify an allocation period. The source pool and basis time periods define the time interval for the allocation to be generated. Time periods can be defined in a dynamic manner, and various mechanisms can be provided for specifying periods such as “today”, “this week”, or a custom time period including exact dates specified by user 100. As described in more detail below, dynamic time periods leverage the “as of” date when an allocation is generated, and also can use the “as of” date to determine appropriate periods. In at least one embodiment, for projects that span differing start and end dates, the system can support Inception to Date allocation periods, making it simpler to span across projects with differing durations.

In at least one embodiment, custom periods are entirely controlled by the period definition. In at least one embodiment, the logic for custom periods does not use any date entered in the “as of” date field.

In at least one embodiment, the system provides additional functionality to enable expanded dynamic allocation periods, for both source pool and basis sections of the dynamic allocation definition. In this manner, the system and method can provide additional standard periods, as well as allowing for greater customization beyond the standard periods. This provides improved precision in using dynamic allocations.

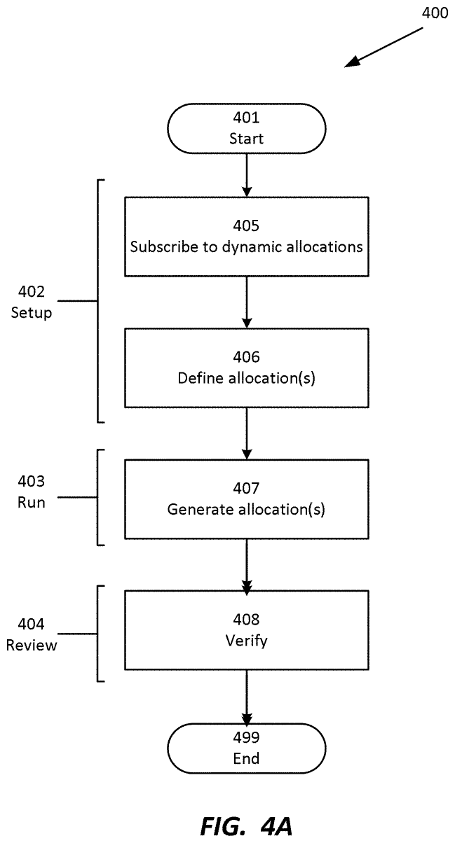

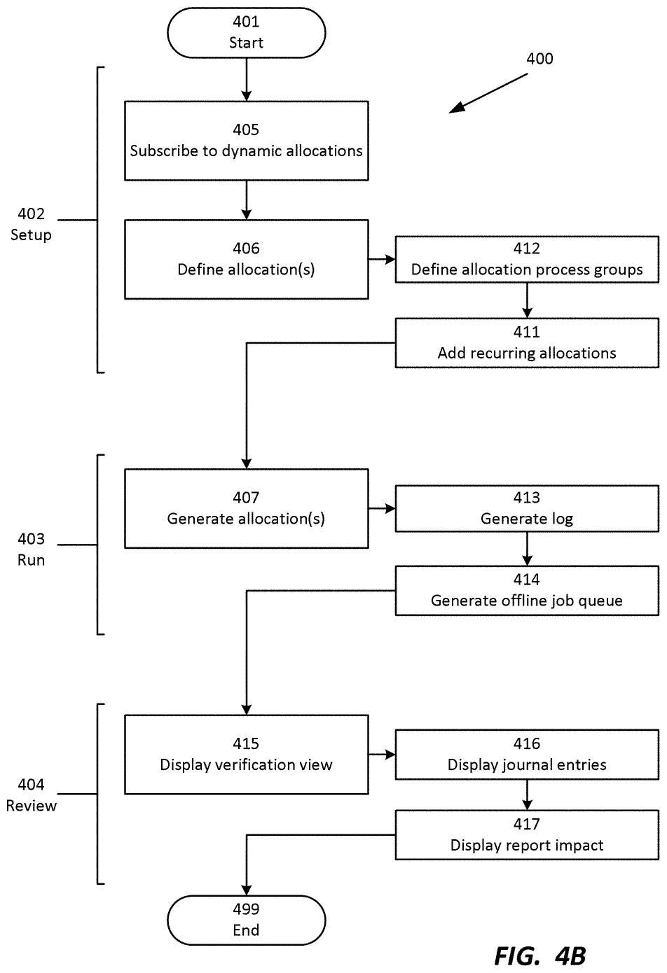

Referring now to FIG. 4A, there is shown a flow diagram depicting an overall dynamic allocation method 400 according to one embodiment. Method 400 includes three stages: setup stage 402, run stage 403, and review stage 404.

The method begins 401. In setup stage 402, user 100 subscribes 405 to dynamic allocations within a software application, such as an accounting software application. Next, at least one account allocation is/are defined 406, either manually or automatically; in at least one embodiment, step 406 includes defining allocation templates.

In run stage 403, at least one account allocation is generated 407 based on the allocation(s) defined in step 406. In at least one embodiment, user 100 can be alerted by any suitable means, such as via email, as to when an account allocation has started as well as when it completes.

In review stage 404, an allocation generated in step 407 can be reviewed and verified 408. Step 408 can include, for example, providing user 100 with a display of the calculations used to reach the distribution figures. In at least one embodiment, functionality can be provided to allow user 100 to drill down into the journal entries and review where the source, basis, and target parameters and amounts came from.

Referring now to FIG. 4B, there is shown a flow diagram depicting additional details of dynamic allocation method 400 according to one embodiment. In setup stage 402, as described above, user 100 subscribes 405 to dynamic allocations. In at least one embodiment, user 100 can also assign permissions for other users to see account allocation options, for example via a General Ledger menu. Such Permissions can be assigned based on a role or user related to access within a General Ledger area.

At least one account allocation is/are defined 406. In at least one embodiment, this account allocation definition is used as a template for allocations associated with user 100 or other entity. In another embodiment, rather than providing user-specific permissions per allocation definition, users may have overall permission to edit or run allocations, within the context of multientity and entity level security.

Once the definition has been created, user 100 can generate allocations as often as needed using the same definition.

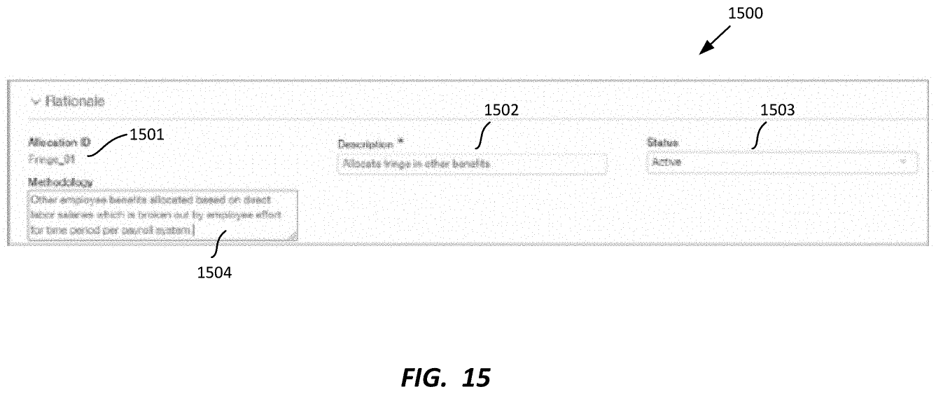

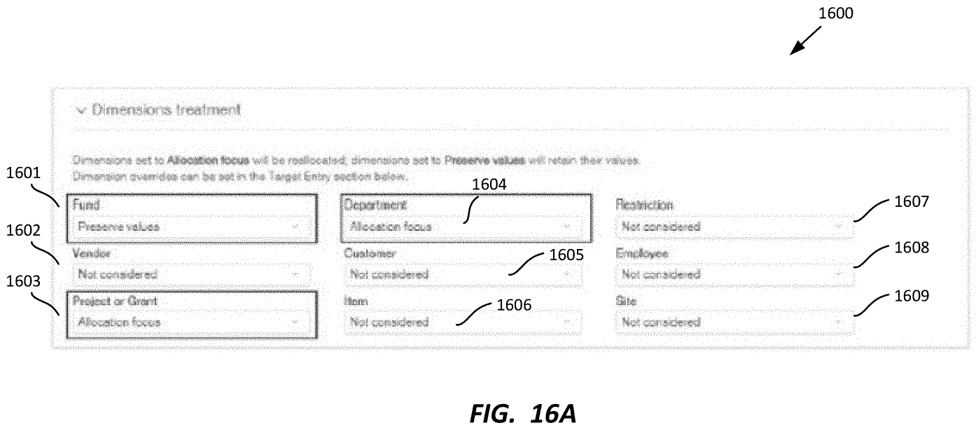

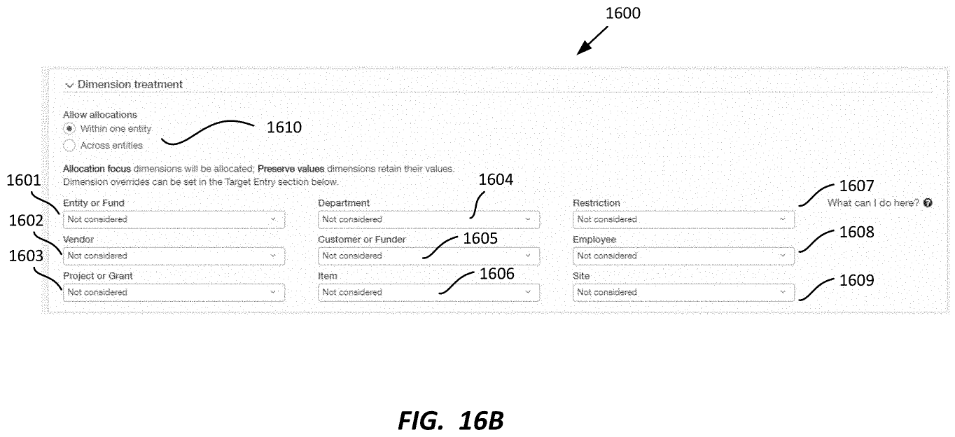

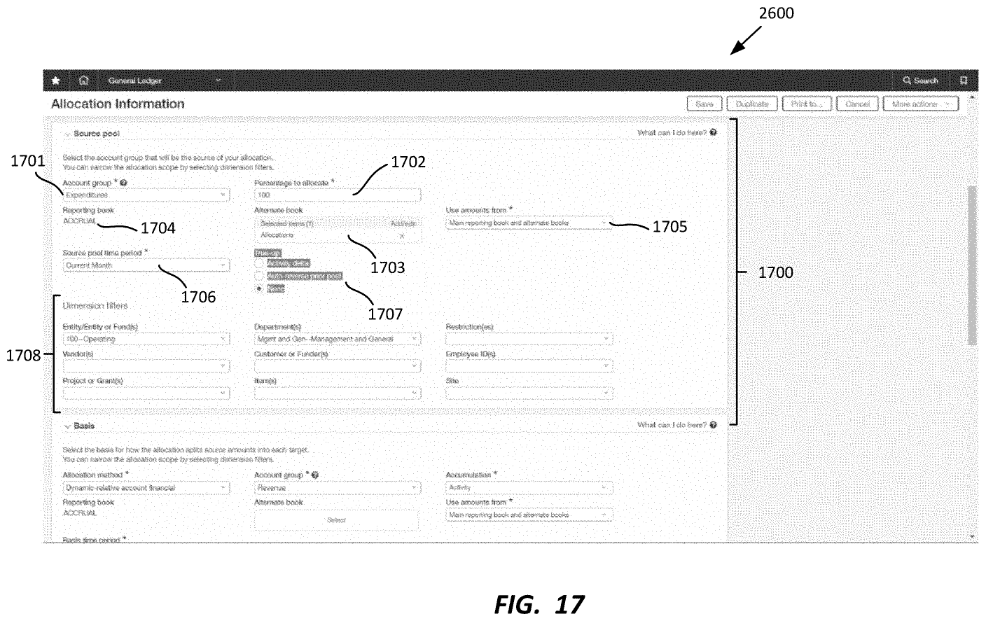

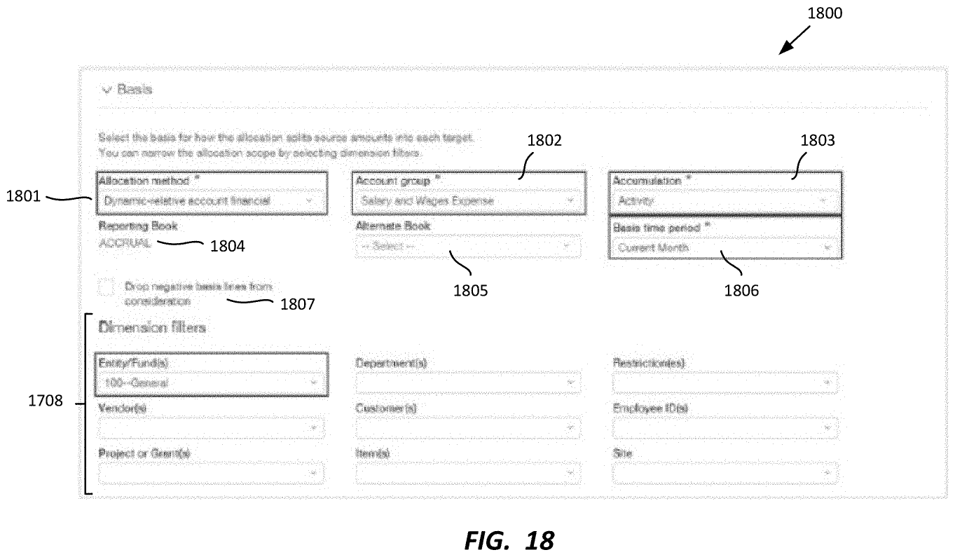

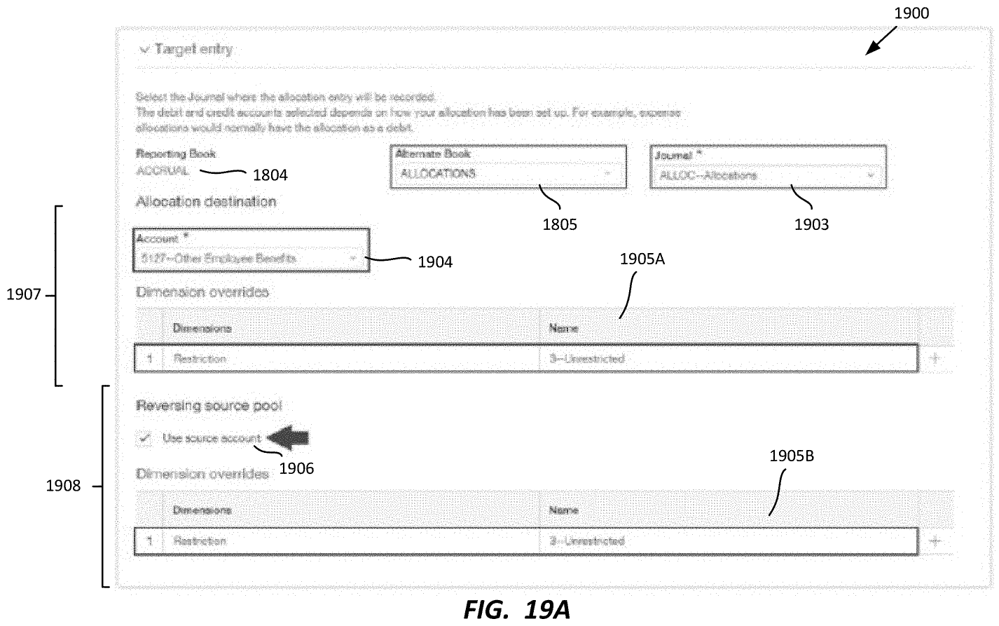

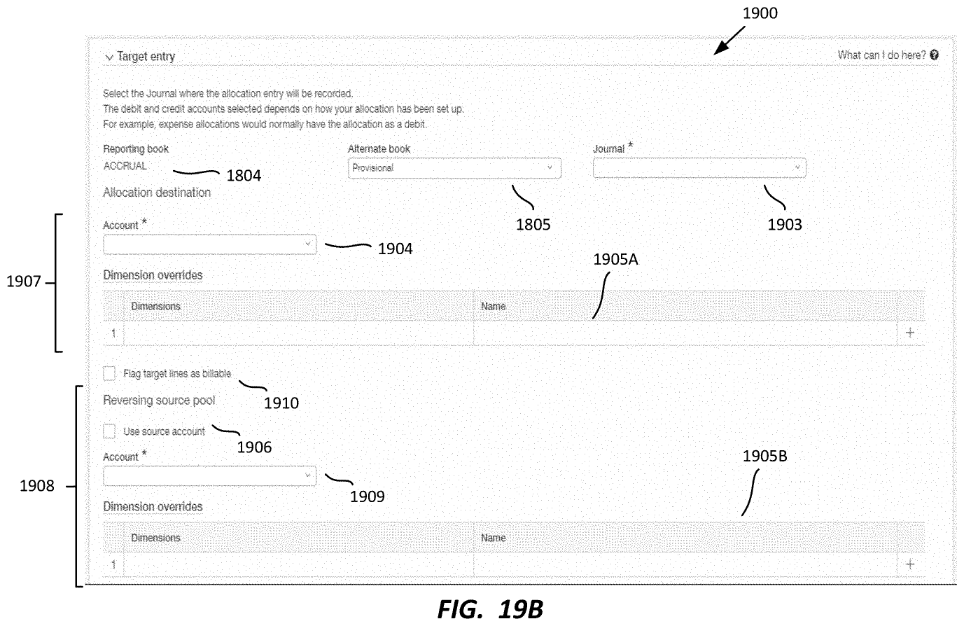

In at least one embodiment, user 100 can set up one or more account allocation(s) using an allocation information screen (also referred to as an allocation definition screen), as described and depicted in more detail below. In a rationale section, described below in connection with FIG. 15, user 100 assigns an ID to his or her account allocation, and adds additional information. In a dimensions treatment section, described below in connection with FIGS. 16A and 16B, user 100 can select how dimensions will factor into allocation calculations. In a source pool section, described below in connection with FIG. 17, user 100 can define where to get the amount to allocate. In a basis section, described below in connection with FIG. 18, user 100 can define how the allocation is distributed. Finally, in a target entry section, described below in connection with FIGS. 19A and 19B, user 100 can select where to record the allocated amounts and the reversal. User 100 then clicks a save button to complete the process.

In at least one embodiment, setup stage 402 also includes steps for defining 412 allocation process groups and adding 411 recurring allocations. In at least one embodiment, steps 412 and/or 411 are optional. In at least one embodiment, recurring allocations can be associated with a timetable so that they can be generated automatically. Allocation process groups can be used to streamline the processing of related allocations or allocations that occur at the same cadence. In addition, recurring allocations can be set for individual allocation definitions or for a group.

Steps 405, 406, 412, and 411 can be performed manually, in response to user input, or automatically based on predefined parameters, machine learning, artificial intelligence, and/or other factors.

In run stage 403, as described above, allocations are generated 407. Step 407 can be performed based on the allocations defined in step 406, the recurring allocations defined in step 411, and/or the allocation process groups defined in step 412.

In at least one embodiment, user 100 initiates step 407 by accessing a Generate Allocations screen and entering the relevant information, as follows:
User 100 can specify a general ledger (GL) posting date for the allocation. This is the date the allocation will be posted to the GL.
User 100 can enter his or her email address or other contact information. In at least one embodiment, allocations are processed offline. An email message can be sent automatically to alert user 100 when the allocation has been processed, and to provide further information about the allocation.
User 100 can specify an “as of” date for the allocation, which determines how the system interprets the time periods for the source and basis. The “as of” date is used to determine the source pool and the basis time periods.
User 100 can specify the account allocation ID or the group allocation to be generated. Information about the selected allocation is displayed, including the members of the allocation, the source pool and basis time periods, the posting journal, and the last time the allocation was posted if it was successfully generated before.
User 100 clicks a generate button. An account allocation log page is displayed. This page shows the status of the allocation just generated, as well as information about other account allocations.

In at least one embodiment, when user 100 initiates the above-described process, the system dynamically finds the source amounts and applies the basis calculation to create a journal entry.

In at least one embodiment, once the allocation has been generated, an email message is automatically sent to user 100, alerting user 100 that the process has completed, and providing additional information about the results of the allocation. In at least one embodiment, results and/or status can also be viewed in a financial report or in the journal that was selected in the allocation definition. If the allocation was set up to record into a book specifically for allocations, user 100 can view a report on the pre- and post-allocation activity levels.

In at least one embodiment, step 417 can be omitted in favor of step 411.

A log is then generated 413 based on the results of steps 407 and/or 411, and an offline job queue can be created 414. In at least one embodiment, the log and offline job queue can be transmitted to user 100 and/or to some other individual, for example by email or by some other means. In at least one embodiment, user 100 can also view the status of the account allocation, as well as other generated account allocations, on by viewing the log and/or queue.

In review stage 404, a verification view can be displayed 415, allowing user 100 to review allocations generated in steps 407 and/or 411. In at least one embodiment, journal entries 410 can be displayed 416 for review by user 100. In at least one embodiment, a report impact view can also be displayed 417 that provides visibility into the difference between the state of the data before and after the allocations generated in step 407. In at least one embodiment, allocations are processed in a separate book so as to be able to provide user 100 with this before/after view. In at least one embodiment, the described system allows user 100 to compare two or more allocation methodologies, for example by performing an allocation under one book, and then performing a different allocation in another book. In review stage 404, user 100 can then be presented with results of both allocations in a side-by-side view for easy comparison.

In at least one embodiment, user 100 can select which of two or more alternative books to apply. In at least one embodiment, the user can combine two or more books, using “bookstacking” functionality (selecting more than one book at a time to be added together). For example, different labor allocations can be applied based on total number of hours, areas of responsibility, employee counts, and/or the like. Combinations are enabled from both a source perspective and a basis perspective. Side-by-side comparison of all of these methodologies can be made available using the techniques described herein.

### Account Allocation Definitions

As described above, in step 406 of the method depicted in FIGS. 4A and 4B, allocation(s) is/are defined. Each account allocation definition allows user 100 to record a rationale used for an allocation, as well as the source pool, basis, and target entry. Once created, this definition can be used to generate allocations to dynamically gather source balances, apply basis calculations, and create allocated entries as desired.

In at least one embodiment, system-generated allocation entries are posted into a journal associated with a user-defined book. Entries may remain in the user-defined book, or they can be moved or copied to another book, for example via duplicate and reverse functions as needed. Accordingly, in at least one embodiment, before user 100 defines account allocations, he or she first defines a book and journal for use with account allocations.

In at least one embodiment, the step of defining allocation(s) 406 includes the following substeps:
User 100 accesses an Add Account Allocation Definitions screen.
User 100 assigns an ID to the account allocation and adds information to a rationale section.
User 100 specifies how dimensions will factor into the allocation calculations in a dimensions treatment section.
User 100 defines where to get the amount to allocate in a source pool section.
User 100 defines how the allocation is distributed in a basis section.
User 100 specifies where to record the allocated amounts and the reversal in a target entry section.
User 100 clicks a button to save the allocation definition.

Although the above steps are described in terms of user 100 actions, any or all of the steps can be performed automatically, using for example machine learning and/or artificial intelligence.

Once user 100 has created an account allocation definition, he or she can initiate generation of an allocation, and can then verify that the system has created an allocated entry as expected.

Constraints within Account Allocation Definitions

In at least one embodiment, certain limitations may exist for account allocation definitions. These limitations are optional, and need not be present. Examples of such limitations include:
Limiting allocations to revenue and expense accounts only.
Limiting allocations to intra-entity allocations only.
Limiting allocations so that they cannot be generated at the top level if the target entry or reversing source pool contains private accounts, private dimensions, or restricted customers or vendors.

In addition, in at least one embodiment, the base currency of the entity may be determined by the currency in the generated allocation. Thus, if global consolidations are involved, with entities having different base currencies, the location where the account allocation is created may determine the currency used in the allocation. For example, if an account allocation definition is created with a base currency of US dollars, the generated allocation entry may automatically be set to US dollars; alternatively, if the account allocation definition is created with a different base currency, then the generated allocation entry may automatically be set to that currency instead. In at least one embodiment, cross-currency allocations cannot be generated; in other embodiments, they are permitted.

### Allocation Information Screen

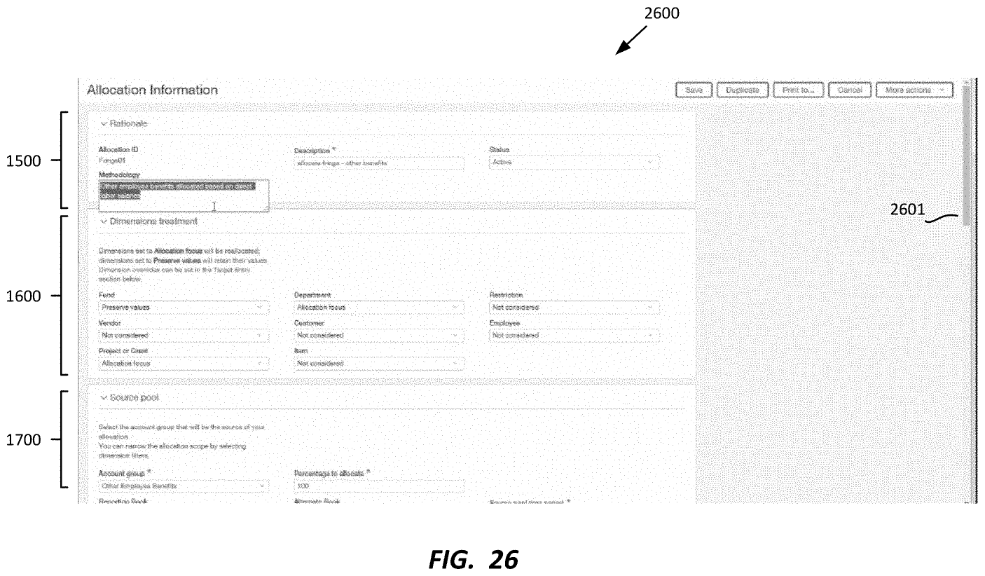

Referring now to FIG. 26, there is shown an example of an allocation information screen 2600 according to one embodiment. Screen 2600 includes various sections that are used for configuring allocations, including rationale section 1500, dimensions treatment section 1600, source pool section 1700, and/or the like. Additional sections may also be included, but may not be immediately visible due to window size limitations. User 100 can use scroll bar 2601 to scroll to other sections.

The various sections included in allocation information screen 2600 will be described in more detail below.

### Rationale

In at least one embodiment, allocation information screen 2600 includes a rationale section, to allow user 100 to name the account allocation and to provide reasoning for how the allocation was set up. Recording why the allocation was set up in a certain way is useful for audit purposes as well as continuity for others who might use the allocation in the future.

Referring now to FIG. 15, there is shown an example of a rationale section 1500 of an allocation information screen 2600, according to one embodiment. As described above, in at least one embodiment, user 100 can start the dynamic allocation by adding information to rationale section 1500 of the allocation information screen.

In at least one embodiment, the following fields may be available:
Allocation ID 1501: This is the name of the allocation that appears in the account allocation definitions list. In the example, an Allocation ID of Fringe01 is specified.
Description 1502: A brief description for the account allocation definition. In the example, the allocation deals with both the fringe account and other employee benefits. Accordingly, a Description of Allocate fringe in other benefits is specified.
Status 1503: A status for the account allocation definition. “Active” means the allocation definition is available to be generated. “Inactive” means the allocation definition is unavailable to be generated.
Methodology 1504: A field that allows user 100 to explain the reasoning behind the configuration of the allocation definition. In the example, the following methodology is specified: Other employee benefits allocated based on direct labor salaries which is broken out by employee effort for time period per payroll system.

### Dimensions Treatment

In at least one embodiment, allocation information screen 2600 includes a dimensions treatment section, to allow user 100 to specify how dimensions should behave during allocation calculations, as well as the level of detail that will be included in created allocation entries.

In at least one embodiment, both standard and user-defined dimensions are available for selection. Selections made here help determine how the allocation calculations are created. User 100 can select any number of dimensions; however, the more dimensions are added, the more complex the allocation calculations will be.

The dimension settings in this section are not the same as the dimension filters that are used to narrow the scope of an allocation. This section determines whether dimensions are considered and how they are considered in the overall allocation calculations. The dimension filter options in the source pool and basis sections (described below) determine which dimension values are used in the source and/or basis calculations.

Referring now to FIG. 16A, there is shown an example of a dimensions treatment section 1600 of an allocation information screen, according to one embodiment. Dimensions treatment section 1600 includes a number of pulldown menus 1601-1609, each of which can be used to specify options for various dimensions.

In at least one embodiment, the following options may be available for each dimension:
Allocation focus: Dimensions set to allocation focus are to be allocated or reclassified based on the calculation method selected in the basis section. These dimensions are included in any dynamic calculations for the basis.
Preserve values: Dimensions set to preserve values keep their original values assigned during initial entry (as determined by the source pool query). These dimensions are included in the calculations for the source and the basis to ensure their proportional distribution is kept when the allocated entry is recorded.
Not considered: Dimensions set to not considered are not used for the calculations during the generation of the allocation but can still be used as a filter to narrow the option description source pool or basis. User 100 can either leave the dimension with no value in the allocated entry, or can apply a single value using target entry dimension overrides as described below.

The example shown in FIG. 16A focuses on two dimensions: Department and Project or Grant. These are the dimensions to be allocated based on the calculation method to be selected in the basis section of the allocation. Accordingly, department menu 1604 and project or grant menu 1603 are set to allocation focus.

In this example, the values of the Fund dimension are to be preserved. Accordingly, fund menu 1601 is set to preserve values.

In this example, the remaining dimensions are not retained for calculation or preservation in this allocation. Accordingly, menus 1602, 1605, 1606, 1607, 1608, and 1609 are set to not considered. In at least one embodiment, an override value can be used for the restriction dimension in the target section, as described below.

In at least one embodiment, allocations can be performed across entities. Referring now to FIG. 16B, there is shown an example of a dimensions treatment section 1600 of an allocation information screen, wherein allocations can be performed across entities, according to one embodiment. Buttons 1610 allow user 100 to specify whether allocations are allowed within one entity or across entities. Menu 1601 allows selection of an entity or fund. Menu 1605 allows selection of a customer or funder.

Using an interface such as shown in the example of FIG. 16B, user 100 can specify how an allocation should be performed when data is found in more than one entity. The allocation can be restricted to one entity, in which case source and basis options are selected from the entity in which the allocation originates; target entries are made in the same entity as reversing source entries. Alternatively the allocation can include more than one entity, even if those entities have different currencies.

If user 100 specifies, via buttons 1610, that allocations can take place across entities, the entity selected as the source entity is used to specify how to trigger inter-entity balancing entries automatically so as to ensure that the generated journal entry is in balance. In at least one embodiment, inter-entity account mapping provides a method for generating these inter-entity balancing entries.

### Dimension Treatment Constraints

In at least one embodiment, to limit complexity in subledger reporting, some dimensions, such as standard dimensions Contract and Warehouse, can be constrained so that they can only be set to not considered. If needed, user 100 can include a value for such dimensions using a dimension override in the target entry section, as described below.

In at least one embodiment, for global consolidation companies, the standard dimension Location can only be set to preserve values or not considered. If needed, user 100 can include a single value for this dimension using a dimension override in the target entry section, as described below.

### Source Pool

In at least one embodiment, allocation information screen includes a source pool section, to allow user 100 to define where the system will dynamically find the amount to use for the allocation.

Referring now to FIG. 17, there is shown an example of a source pool section 1700 in the context of allocation information screen 2600. Source pool section 1700 allows user 100 to specify the source of the funds to be used for the allocation. User 100 can also specify dimension filters to narrow the scope of the allocation by limiting the source pool to a specific dimension.

In the depicted example, source pool section 1700 includes various menus/buttons/fields 1701 through 1708, as follows.

Account group menu 1701 specifies the source of the allocation. In at least one embodiment, only accounts that were previously selected in the account group are listed as selections in menu 1701. If user 100 wants to add dimension filters to the selected accounts, the filters can be defined explicitly in dimension filters section 1708, described below. In at least one embodiment, user 100 can select an account group, or an account group of groups, from menu 1701. In at least one embodiment, computational or statistical account groups cannot be selected; in another embodiment, they can be selected.

To allocate a single account, user 100 creates an account group that has only one account in the group. In at least one embodiment, the system only supports account groups that include members with an account type of income statement account. In another embodiment, the system also supports accounts that have the account type balance sheet account for account allocations. In the depicted example, the source of the allocation amounts is an Expenditures account group, as shown in menu 1701.

Percentage to allocate menu 1702 specifies the percentage of the source pool to be allocated. In at least one embodiment, this percentage will be applied during calculation to the source amount. In the depicted example, 100% of the amounts found are to be allocated, as shown in menu 1702.

In at least one embodiment, a currency menu (not shown) may be included, to allow user 100 to select the base currency used in the entity where the allocation is processed.

Reporting book field 1704 specifies which reporting book is to be used (either Accrual or Cash). If global consolidations are not being used, this selection can be made automatically based on which accounting method was chosen when the general ledger was set up.

Alternate book menu 1703 is used to indicate whether an alternate book should be used. If user 100 prefers to use just the reporting book as specified in field 1704, he or she can leave menu 1703 unselected. Alternatively, user 100 can specify one or more alternate books via menu 1703, including for example, GAAP, Tax, and/or user-defined books. In at least one embodiment, any number of alternate books may be selected. Using the reporting book specified in field 1704 as well as any alternate books specified via menu 1703 allows the system to factor in previous allocations into future allocations without having to move previously generated allocations into the specified reporting book. For example, allocations can be recorded in a specific allocation book on an ongoing basis while still factoring in the impact on future allocations using “bookstacking” with an Accrual reporting book. This saves time when moving through the allocation process.

Menu 1705 allows user 100 to specify where amounts will be taken from. User 100 can select “Main reporting book and alternate book(s)”, so that all selected alternate books and the reporting book are used for the basis calculation. Alternatively, user 100 can select “Alternate books only”, so that only selected alternate books are used for basis calculation.

Source pool time period menu 1706 specifies the default time interval for the allocation to be generated. In at least one embodiment, user 100 can set up the allocation definition to allow for any suitable time period, such as, for example, if the user needs to run payroll allocations twice a month. When the allocation is generated, the As of Date field uses this value to determine the actual dates for the allocation source activity. For example, if user 100 sets the source pool time period for Prior Month, and when generating the allocation user 100 sets the As of Date to Sep. 1, 2018, the allocation calculations will be based on the activity in the source pool during August 2018. In at least one embodiment, any suitable time period option can be specified.

User 100 can also generate allocations that require different time periods than the ones listed above, as desired.

In the depicted example, the source of the source pool time period is the current month, as shown in menu 1706.

In at least one embodiment, source pool section 1700 also includes dimension filters subsection 1708, which can be used to narrow the scope of the allocation to the precise dimension details desired, for example by limiting the source pool to a specific department or location group. Dimension filters function much like report filters. As described above, a dimension treatment section of the Add Account Allocation Definitions screen allows user 100 to specify how dimensions should be treated during calculation. Source pool dimension filters, as specified in dimension filters subsection 1708 of source pool section 1700, indicate whether the system should consider all values, or use specific values, when dynamically pulling the source amounts to be allocated. If user 100 wants to use a dimension that includes its child records, a dimension group is created and selected here. For example, if Entity A has Locations 1 and 2, user 100 can select Entity A as a dimension to cause the account allocation to only pull what is in Entity A, rather than Entity A and Locations 1 and 2. Alternatively, if user 100 wants both Entity A and Locations 1 and 2, he or she can create a dimension group that includes all three records. Additional details are provided below.

In the depicted example, the scope of the allocation will be narrowed to two dimension filters: Entity/Funds dimension 100—General and Department dimension Management and General, as shown in dimension filters subsection 1708. Thus, when the system looks in the Expenditures account group (as specified by menu 1701), it will only include in the allocation the amounts it finds in both Entity/Funds dimension 100—General and Department dimension Management and General.

User 100 can specify a true-up mechanism via true-up selector 1707. In at least one embodiment, options include Activity delta, Auto-reverse prior post, or None. When Activity delta is selected, the system checks to ensure the source pool account group is the same, or includes the selection in the reversing source pool account. The auto-reverse prior post is an alternative method and instead will seek to reverse any prior allocations that occurred within the same time frame (such as year-to-date). Additional details are provided below.

In at least one embodiment, when Activity delta is selected, an extra layer of validation is included for the allocation. For example, in at least one embodiment, allocations can be run at any desired frequency, so as to provide realtime and/or near-real-time accuracy. If user 100 creates an allocation that needs to be run more often than once a period (payroll, for example), selecting Activity delta causes the system to validate that the account setup is designed to clear the source amounts with each allocation generation. This is done by making sure that the accounts selected for the source pool are used as the reversing source pool selection, or if an alternate specific account is used for the reversal, that it is included in the source pool account group so that it removes any prior allocation activity. If the source pool includes the reversing source pool account or is set to reverse the source directly, user 100 can run the same allocation multiple times in the same time period. When the allocation is generated, the allocation pulls the source pool accounts and automatically derives only the amount recorded since the last allocation because the last allocated amount has already been removed by the reversing entry (as long as the earlier allocation has been moved into the source book). Thus, user 100 can run a payroll allocation more often, such as every two weeks, and be confident that each run will only allocate activity that has occurred since the previous allocation.

In at least one embodiment, when auto-reverse prior post is selected, the originally generated allocation is automatically reversed using the posting date of the original allocation as the reversal date, so as to automatically reverse a prior post in order to “true-up” the allocated amounts. For example, if user 100 has already run an allocation for payroll, and it is now time to run another one, user 100 can first reverse the last payroll allocation the same day he or she needs to run a new payroll allocation (so that reports run for the interim period will reflect the allocation amounts accurate at the time), then run the allocation to “true up” the allocated amounts.

For example, suppose an allocation generated March 15th found and allocated $200 to the defined target. Now, on March 31st, an allocation generated for the full month would be $500, which includes the $200 from the March 15th allocation. The March 15th allocation needs to be replaced with the March 31st allocation. If user 100 selected the auto-reverse prior post option in the allocation definition, the system performs the following steps:
Reverse the $200 allocation as of March 31st; and
Run the current allocation in total for $500 as of March 31st.

This ensures that interim reporting reflects the appropriate history at the time, while still updating the allocation according to the new source and basis calculation.

If the allocation is run a third time in the same period, the reversal that occurs reverses the last posting (which is already cumulative for the first two generations) and leaves any prior reversals intact.

### Basis

Referring also to FIG. 18, there is shown an example of basis section 1800, which may also be included allocation information screen 2600. Basis section 1800 allows user 100 to define how the allocation splits the source pool amount into each allocation-focused dimension. Dimension filters, specified in subsection 1708, allow user 100 to narrow the scope of the amounts considered to get the dynamic basis distribution. The basis, as specified in basis section 1800, is the blueprint for the calculations of the allocation focus dimensions percentage split.

In the depicted example, basis section 1800 includes various menus/buttons/fields 1801 through 1807, as well as dimension filters subsection 1708, as follows.

Allocation method menu 1801 determines how the source pool is distributed within the allocated entry. If user 100 selects Dynamic—relative account financial (as shown in this example), the system dynamically calculates the applied percentage split by analyzing the proportion of the allocation focus dimensions within the basis account group after any basis dimension filters are applied. If user 100 selects Dynamic—relative account statistical, the system uses the proportions of the statistical account amounts defined in the statistical account to derive allocation percentages. In at least one embodiment, statistical accounts are used to track non-financial data, such as labor hours, number of members, or square footage. Tracking key metrics in this type of account allows user 100 to split the allocation based on the information in a statistical account. For example, user 100 can track labor hours in a statistical account, and can then create an allocation for a fringe expense based on the labor hours tracked in the statistical account and have the allocation basis use the labor hours per project as the basis for the allocation split. In at least one embodiment, only account groups with the category Statistical and Statistical Category can be selected when the basis Dynamic—relative account statistical is used. In at least one embodiment, the accumulation method user 100 selects for the Basis only allows for activity. This means that when the user uses Dynamic—relative account balances statistical as the basis for the allocation, the system takes into account the time period associated with the statistical amounts the user is using, and evaluates how the statistical amounts are currently tracked.

In at least one embodiment, dimensions set as Allocation Focus (as depicted, for example, in menus 1603,1604 of FIG. 16A) are the only dimensions considered when deriving the basis portion of the allocation distribution. When the allocation is generated, the relative account selection provides a balance analysis by looking at the basis period in conjunction with the As of Date (similar to running a report to look up amounts). The resulting values return one line for each unique dimension combination found. The values are then used to calculate the percentage splits.

Account group menu 1802 specifies the account group on which the allocation split should be based. In at least one embodiment, only accounts selected in the account group are considered by the allocation. If user 100 needs dimension filters added to the selected accounts, these can be defined in dimension filters subsection 1708 of basis section 1800.

In account group menu 1802, user 100 can select an account group or an account group of groups. In at least one embodiment, computational or statistical account groups cannot be selected; in another embodiment, such selections are permitted. To allocate a single account, user 100 can create an account group that has only one account in the group. In the depicted example, the Salary and Wages Expense account group has been selected, as shown in menu 1802.

Accumulation menu 1803 determines how the amounts within the basis accounts are interpreted in deriving amounts for the allocation split. Options include Activity or Ending Balances. In the depicted example, Activity has been selected, as shown in menu 1803.

Reporting book field 1804 specifies which reporting book is to be used (either Accrual or Cash). If global consolidations are not being used, this selection can be made automatically based on which accounting method was chosen when the general ledger was set up.

Alternate book menu 1805 is used to indicate whether an alternate book should be used for generating the allocated entry. If user 100 prefers to use just the reporting book as specified in field 1804, he or she can leave menu 1805 unselected. If user 100 prefers to use just the reporting book as specified in field 1804, he or she can leave menu 1805 unselected. Alternatively, user 100 can specify one or more alternate books via menu 1805, including for example, GAAP, Tax, and/or user-defined books. In at least one embodiment, any number of alternate books may be selected. Using the reporting book specified in field 1804 as well as any alternate books specified via menu 1805 allows the system to factor in previous allocations into future allocations without having to move previously generated allocations into the specified reporting book. For example, allocations can be recorded in a specific allocation book on an ongoing basis while still factoring in the impact on future allocations using “bookstacking” with an Accrual reporting book. This saves time when moving through the allocation process.

Basis time period menu 1806 specifies the default time interval for the allocation to be generated. The same time period can be used as was used for the source pool. Alternatively, the user can select a different time period for the basis such as, for example, if the user needs to run payroll allocations twice a month. When the allocation is generated, the As of Date field uses this value to determine the actual dates for the allocation source activity. For example, if user 100 sets the source pool time period for Prior Month, and when generating the allocation user 100 sets the As of Date to Sep. 1, 2018, the allocation calculations will be based on the activity in the source pool during August 2018. In at least one embodiment, the following time period options are available:
Current Month
Prior Month
Current Quarter
Prior Quarter
Current Year
Current Year To Date
Prior Year
Prior Year Current Month
Prior Year Current Quarter
Fiscal—Current Quarter
Fiscal—Prior Quarter
Fiscal—Current Year
Fiscal—Current Year to Date
Fiscal—Prior Year
Inception to Date; in one embodiment, this time period is only available when the Project dimension is set to Allocation focus and the reporting period is enabled.

In the depicted example, the current month is selected as the basis time period, as shown in menu 1806.

As shown in the depicted example, a Drop negative basis lines from consideration checkbox 1807 can be included. When checked, the regular balances of the accounts in the selected account group are reviewed and any negative balances are not considered in the basis calculation. If left unchecked, and a negative balance is found in the selected account group, amounts may be taken away rather than given during the allocation due to the impact of a negative line. In at least one embodiment, this option is only available if all the accounts in the account group have the same balance type.

In at least one embodiment, basis section 1800 also includes dimension filters subsection 1708, which can be used to specify whether the system should consider all values, or use specific values in dynamically pulling the basis amounts to consider when deriving the basis splits. Dimension filters function much like report filters. As described above, a dimension treatment section of the Add Account Allocation Definitions screen allows user 100 to specify how dimensions should be treated during calculation.

When a dimension is set to Not Considered, it will not be considered as part of the calculations of the basis split. However, it can still be used to narrow the scope of the basis amounts used to derive the split. For example, if user 100 sets the Department dimension to Allocation Focus and the Projects dimension to Not Considered in the Dimension Treatment, the Project dimension can still be used to narrow the focus of the basis amounts used in the calculation of the split. For example, user 100 can filter for Project X to narrow the scope of the basis for only Departments that have transactions associated with Project X. If user 100 wants to use a dimension that includes its child records, a dimension group can be created and selected here. For example, Entity A has Locations 1 and 2, when user 100 selects Entity A as a dimension here, the account allocation only pulls what is in Entity A, not Entity A and Locations 1 and 2. If user 100 wants both Entity A and Locations 1 and 2, he or she can create a dimension group that includes all three records.

In the depicted example, one dimension filter is applied: Entity/Funds dimension 100—General, as shown in dimension filters subsection 1708. Thus, only those amounts from the 100—General account will be considered as part of the calculations of the basis split.

### Target Entry

Referring now to FIGS. 19A and 19B, there are shown examples of target entry section 1900, which may also be included in allocation information screen 2600. Target entry section 1900 is used to specify where the allocated entry should be posted. User 100 can select the journal where the allocated entry will be recorded, and can select the accounts to be used for the allocation destination and reversing source pool.

By posting the allocation to a user-defined allocation book, user 100 can report on pre- and post-allocation activity levels. Allocated amounts can be kept in the allocation book, or moved using copy and reverse to another book (such as accrual). In at least one embodiment, user 100 can only initially generate allocations into user-defined books, so as to ensure there is an opportunity for verification.

In the depicted examples, target entry section 1900 includes various menus/buttons/fields 1804, 1805, 1903, 1904, 1905A, 1906, 1908, 1909, and 1910, as follows.

Reporting book field 1804 specifies which reporting book is to be used (either Accrual or Cash). If global consolidations are not being used, this selection can be made automatically based on which accounting method was chosen when the general ledger was set up.

Alternate book menu 1805 is used to indicate whether an alternate book should be used for generating the allocated entry. If user 100 prefers to use just the reporting book as specified in field 1804, he or she can leave menu 1805 unselected. Alternatively, user 100 can specify one or more alternate books via menu 1805, including for example, GAAP, Tax, and/or user-defined books. In at least one embodiment, any number of alternate books may be selected. In at least one embodiment, only user-defined books are available for target entry selection.

In the depicted examples, the selected reporting book is Accrual, as shown in field 1804. However, since Allocations must be posted to a user-defined book, an alternate book is also selected. In the example depicted in FIG. 19A, as shown in field 1805, the Allocations book has been selected as alternate; accordingly, the Accrual reporting book will be replaced with this alternate book selection. In the example depicted in FIG. 19B, as shown in field 1805, the Provisional book has been selected as alternate; accordingly, the Accrual reporting book will be replaced with this alternate book selection.

Journal menu 1903 is used to indicate the journal where the allocation should be recorded when generated. The selection within alternate book menu 1805 determines the options available for selection in journal menu 1903. If a journal is selected that does not require approvals, the allocation generation will post the entry. If a journal is selected that requires approvals, then a review prior to post is available. Due to the size of allocations, it may be easier to review the results by looking at the impact on a financial statement rather than at the transactions. If user 100 has created the allocation definition but has not run and posted the allocation to the selected journal, he or she can still change the allocation definition journal selection. If user 100 has already posted an allocation to the selected journal, then in at least one embodiment user 100 cannot change the journal selection. To select a different journal, user 100 can duplicate the existing allocation definition, and then change the journal selection. In the example depicted in FIG. 19A, the ALLOC—Allocation journal is selected as the destination for posting the allocation, as shown in menu 1903.

Allocation destination subsection 1907 specifies the allocation destination. Account menu 1904 specifies the target account for the allocated entry. In at least one embodiment, menu 1904 uses the dimension values derived in the basis split, which is a combination of the basis amounts with the amounts of the dimensions set to Preserved values, nested in proportionally. In at least one embodiment, dimensions treated as Not Considered will not contain a value on the allocation destination entry unless a dimension override is used to provide a single value to all lines. In the example depicted in FIG. 19A, Other Employee Benefits is selected as the allocation destination account, as shown in menu 1904.

Allocation destination subsection 1907 also includes dimension overrides table 1905A, which allows user 100 to apply dimension values to all lines of the allocation entry allocation by adding a dimension and specifying a value. When user 100 adds a dimension to table 1905A, all lines in the allocation destination entry include the dimension value selected in table 1905A, as a default value. For example, if user 100 wants all lines of the allocation portion of the entry to include the location Canada, and he or she sets Location to Not Considered in the Dimension treatment section, user 100 enters the Location dimension in table 1905A and sets the value to Canada. Once the allocation is generated, any resulting lines of the allocation portion of the entry will include Canada as the location.

In at least one embodiment, when Project Billing is enabled within the projects configuration for the general ledger and the journal used to record the allocation, user 100 can check box 1910, as shown in the example depicted in FIG. 19B, to flag lines in the allocation target as billable. This allows allocated amounts, such as overhead, to be billed to clients as invoices are generated. User 100 can enable project billing in the general ledger. In at least one embodiment, for the project billing flag to be available in the account allocation definition, the general ledger must be configured for project billing. Alternatively, user 100 can enable project billing in a user-defined journal. In at least one embodiment, the target journal also must be enabled for project billing to be able to flag lines as billable.

Reversing source pool subsection 1908 allows user 100 to specify whether the original dimension values on the source balances should be used for any dimensions treated with allocation focus and preserve values. Dimensions treated as not considered will not contain a value on the reversing source pool entry unless a dimension override is used to provide a single value to all lines.

Checkbox 1906 specifies whether a source account will be used. When checkbox 1906 is checked, as shown in FIG. 19A, the reversing source pool uses the same accounts as the selected source pool account group. Then, only accounts that include dimensions set to Allocation Focus and/or Preserve Values are reversed. Dimensions set in the Dimensions Treatment section to Not Considered are ignored both by the source and basis calculations, and any reversing actions that take place in the Target entry. When left unchecked, as shown in FIG. 19B, user 100 can select a reversing source pool account from menu 1909.

Dimension overrides table 1905B operates similarly to dimension overrides tables 1905A, for the reversing source pool.

### Account Allocation Groups

In at least one embodiment, the described system provides functionality for adding, editing, and/or deleting account allocation groups. When several allocations are to be run on the same interval (for example, at month end), an allocation group allows processing of these allocations in an efficient way. In at least one embodiment, user 100 can specify the order in which the members of an allocation group should be processed. This can be useful, for example, if an allocation is dependent on another allocation that should be processed first.

### Adding an Allocation Group

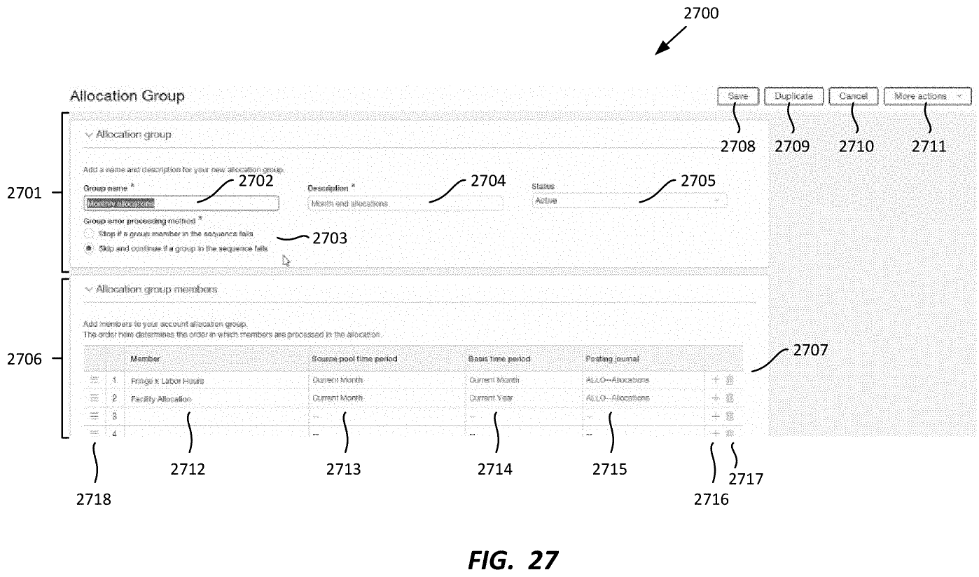

Referring now to FIG. 27, there is shown a screen shot depicting an example of screen 2700 for configuring an allocation group, according to one embodiment.

User 100 can initiate the creation of an allocation group by selecting an Add option. Allocation group section 2701 allows user 100 to add identification details for the allocation group as follows:
Group name 2702: This is the name of the allocation group that is seen when selected for generation and for reviewing results. In at least one embodiment, the allocation group name can be edited after the group has been saved.
Description 2704: A brief description for the allocation group.
Status 2705: Status for the allocation group:
   Active: the allocation group is available to be generated.
   Inactive: the allocation group is unavailable to be generated.
Group error processing method 2703: Specifies how the system should handle any errors it encounters when processing the group allocation members:
   Stop if a group member in the sequence fails: The system will stop the allocation process and not move forward once a member of the allocation group encounters errors.
   Skip and continue if a group in the sequence fails: The system will skip the allocation member if an error is encountered, then continue processing starting with the next member of the group.

Allocation group members section 2706 allows user 100 to select and order group members, via table 2707. In table 2707, user 100 can select an allocation member from member drop down menu 2712. Then, information about the selected allocation is displayed, including source pool time period 2713, basis time period 2714, and posting journal 2715 for the allocation. Button 2716 can be used to add a member to table 2707. Button 2717 can be used to delete a member from table 2707. Button 2718 can be used to reorder members in table 2707. Members will be processed in the allocation according to the order specified in table 2707.

Once user 100 has added as many members as desired to the allocation group, and has specified the order in which they should be processed, user 100 clicks Save button 2708.

In at least one embodiment, user 100 can change the columns displayed in table 2707.

### Editing or Deleting an Allocation Group

In at least one embodiment, user 100 can edit previously defined allocation groups. In at least one embodiment, edits to allocation groups will only impact future calculations, not previously generated allocations. To edit an account allocation group, user 100 opens the allocation group, and activates an Edit function, for example from More actions menu 2711. User 100 makes any desired changes and clicks Save button 2708.

In at least one embodiment, user 100 can delete previously defined allocation groups. To delete an account allocation group, user 100 opens the allocation group and activates a Delete function, for example from More actions menu 2711. A confirmation dialog box opens, allowing user 100 to confirm or cancel the deletion.

In at least one embodiment, Duplicate button 2709 can be used to duplicate the currently displayed allocation group. Cancel button 2710 cancels the current action and dismisses screen 2700.

### Field-by-Field Descriptions

In various embodiments, any suitable fields, buttons, and menus can be included on allocation group screen 2700.

The following are examples of fields that can be included:
Links
   Edit: Click to edit the selected account allocation group. (In at least one embodiment, this option appears only if the system is displaying an existing, saved allocation group).
   View: Click to view the selected account allocation group.
Columns
   Allocation definition group: The name/ID of the account allocation group.
   Group description: The brief description of the allocation group.
Buttons
   Add: Adds a new account allocation group.
   Delete: Delete the selected account allocation group.
   Done: Closes the list.
   Export: Exports the account allocation group list to a supported file format, such as CSV, Excel, Word, or PDF.

### Account Allocation Log

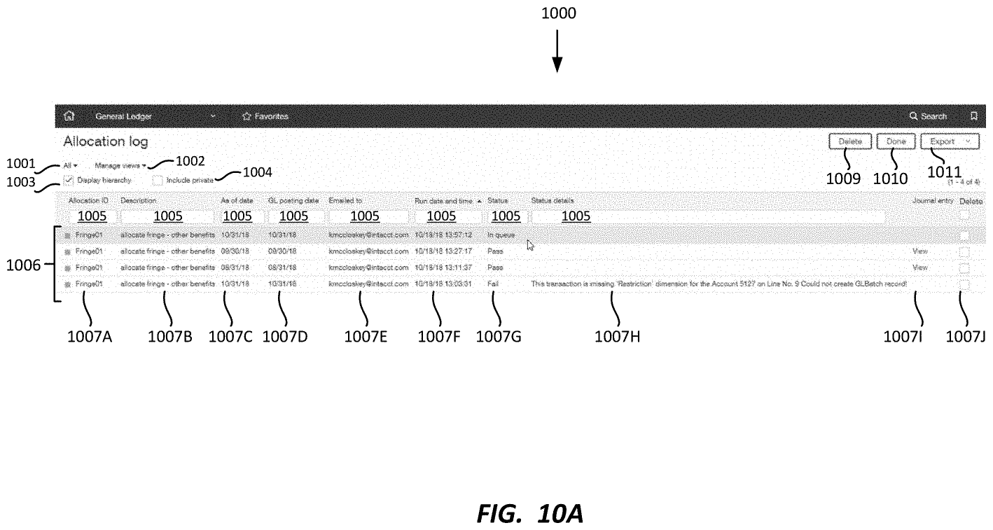

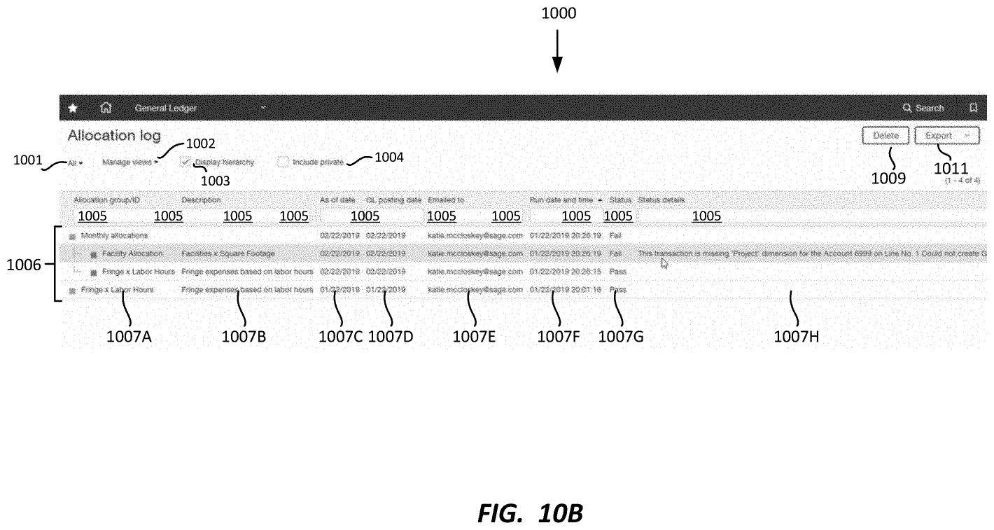

Referring now to FIGS. 10A and 10B, there are shown examples of screens 1000 for displaying an account allocation log 1006 that includes the status of allocations that are in progress or have been completed. FIG. 10A depicts an example wherein individual allocations were run; FIG. 10B depicts an example wherein an allocation group was run, and shows the members of the allocation group.

Account allocation log 1006 indicates which allocations have been processed and recorded, and provides information as to any errors encountered in generation. It also provides quick access to the journal entry for each successful allocation.

In at least one embodiment, user 100 can view account allocation log 1006 and/or the journal entry associated with allocation log 1006. The allocation journal entry displays the entries made when the allocation was successfully generated and recorded.

In at least one embodiment, by default, allocation log 1006 may use icons and/or indentation to show how grouped allocations are structured. User 100 can view the status of each allocation group member in either a flat or hierarchical view, and can click into the journal entry associated with each allocation.

Menu 1001 specifies whether all or a subset of allocations should be shown. Manage views menu 1002 allows user 100 to specify the type and nature of views to be displayed. Display hierarchy checkbox 1003 allows user 100 to toggle between flat and hierarchical views of allocation log 1006, while still allowing user 100 to sort and search for allocations in either view. Include private checkbox 1004 allows user 100 to specify whether allocation log 1006 should include private allocations (“Entity private”).

In at least one embodiment, allocation log 1006 displays the following columns:
Allocation group/ID column 1007A: Indicates the Allocation ID assigned to the allocation when it was created.
Description column 1007B: Includes the brief description of the allocation added when it was created.
As of date column 1007C: Indicates the As of date from the Generate Allocations session used to determine the Source pool and the Basis time periods.
GL Posting Date column 1007D: Indicates the date from the Generate Allocations session entered for when the transaction posts to the GL.
Emailed to column 1007E: Indicates the email address of the user who generated the allocation.
Run date and time column 1007F: Indicates the time and date the account allocation was generated.
Status column 1007G: Indicates the status of the allocation.
   Pass: The allocation completed successfully. An email is sent to the specified recipient with more information about the allocation and a link to the journal entry it was posted to.
   Fail: The allocation encountered a processing error. The Status details column provides a short summary of the error(s) encountered. An email with more details is sent to the specified recipient.
   In progress: The allocation is currently being processed. An email with more information about the allocation status is sent to the specified recipient once it completes.
Status Details column 1007H: If the allocation failed, a short summary of the error(s) encountered is displayed here.
Journal entry column 1007: User 100 can click a View link to see the journal entry for the account allocation. If the allocation is in progress, or has failed, a View link is not available.
Delete column 1007J: User 100 can click a checkbox in this column to delete the allocation.

In at least one embodiment, screen 1000 may include buttons to perform functions such as:
Delete button 1009: Deletes the selected allocation journal entries.
Done button 1010: Closes the list.
Export button 1011: Initiates export of the account allocation log to any of several different file formats, such as CSV, Excel, Word, and/or PDF.

In at least one embodiment, user 100 can enter text in fields 1005 to filter the display of allocation log 1006 to those entries that match the entered text.

### Verify Account Allocations

In at least one embodiment, after an allocation is generated, a log page such as screen 1000 can be used to allow user 100 to view the results of the allocation. In at least one embodiment, user 100 can also use a log page such as screen 1000 as a starting point for verifying calculations made during the allocation.

### Statement of Functional Expenses Report

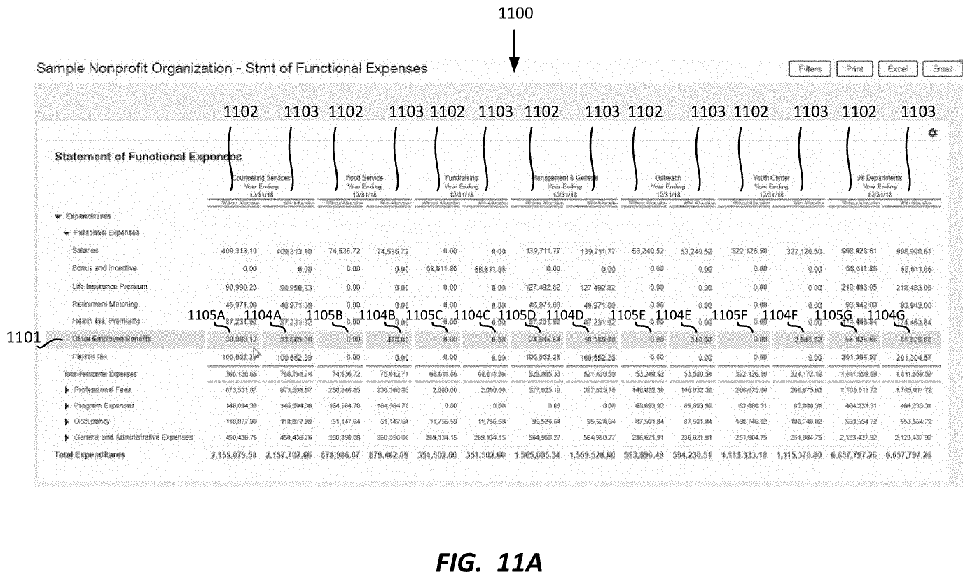

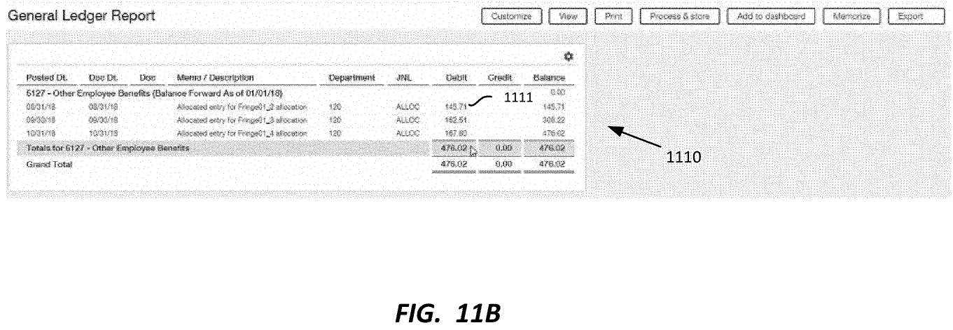

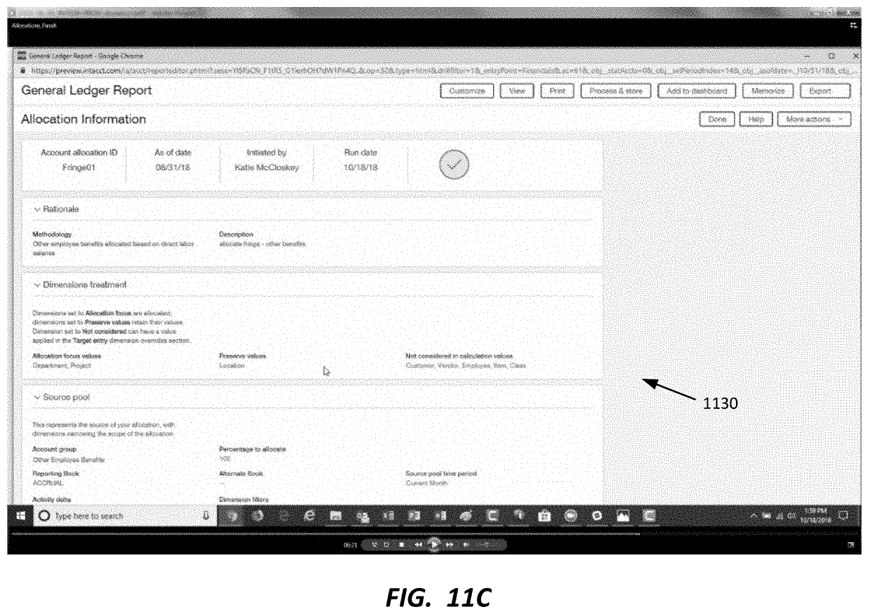

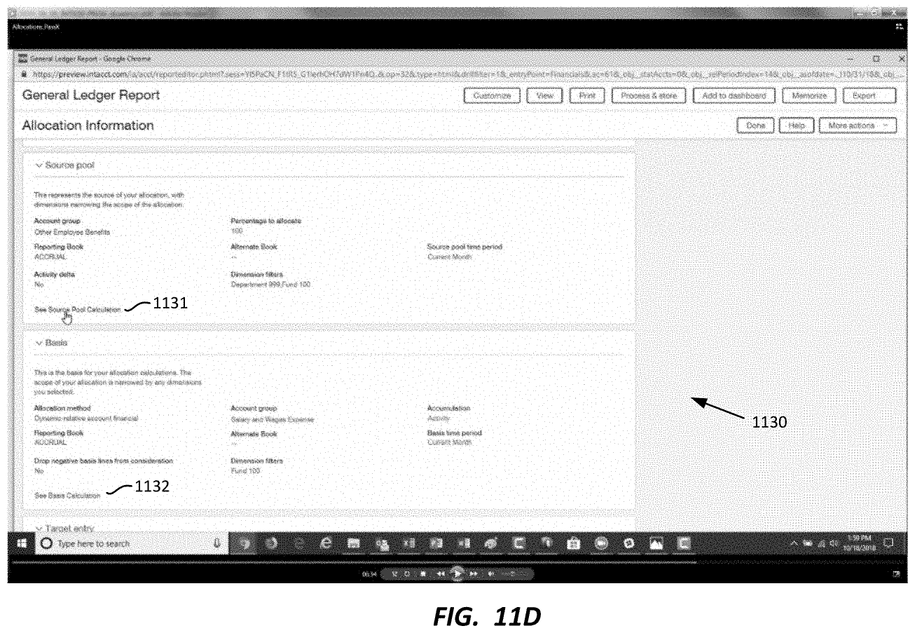

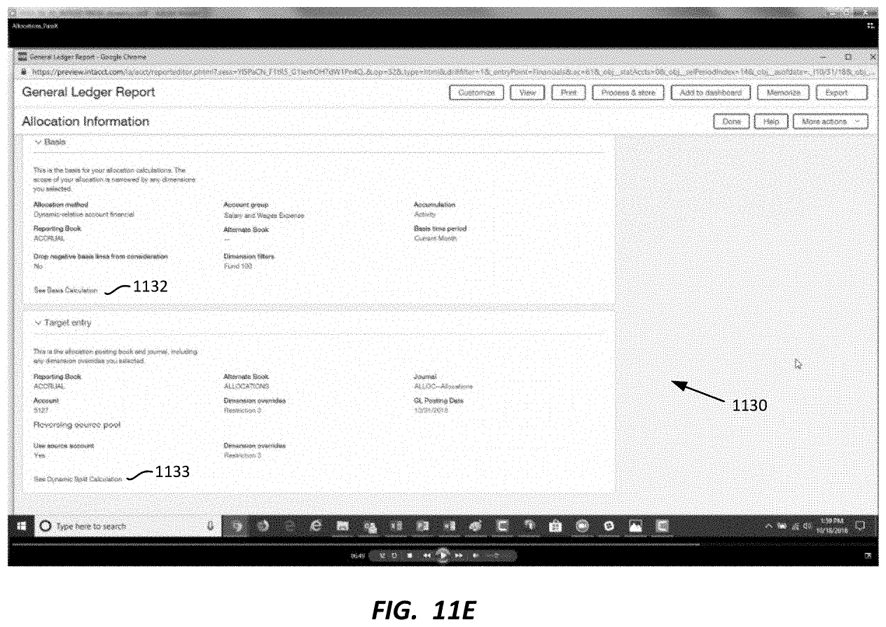

In at least one embodiment, the system can also generate a Statement of Functional Expenses report to allow user 100 to review an allocation and verify that amounts were moved in the expected manner. Referring now to FIG. 11A, there is shown an example of such a report 1100, including a display of balances of different accounts before and after an allocation was run. Other Employee Benefits Row 1101 shows the before and after balances based on the allocation settings. Specifically, columns 1102 show values before the allocation, and columns 1103 show values after the allocation. In this example, values 1104A, 1104B, 1104E, and 1104F have increased (as compared with values 1105A, 1105B, 1105E, and 1105F) as a result of the allocation, while value 1104D has decreased (as compared with value 1105D) as a result of the allocation.

In at least one embodiment, user 100 can click on any of the values shown in report 1100 to see more details. Referring now to FIG. 11B, there is shown an example of general ledger report 1110 as may be displayed after user 100 clicks on value 1104B. Report 1110 shows details concerning how value 1104B was affected by the allocation.

### Allocation Journal Entry Report

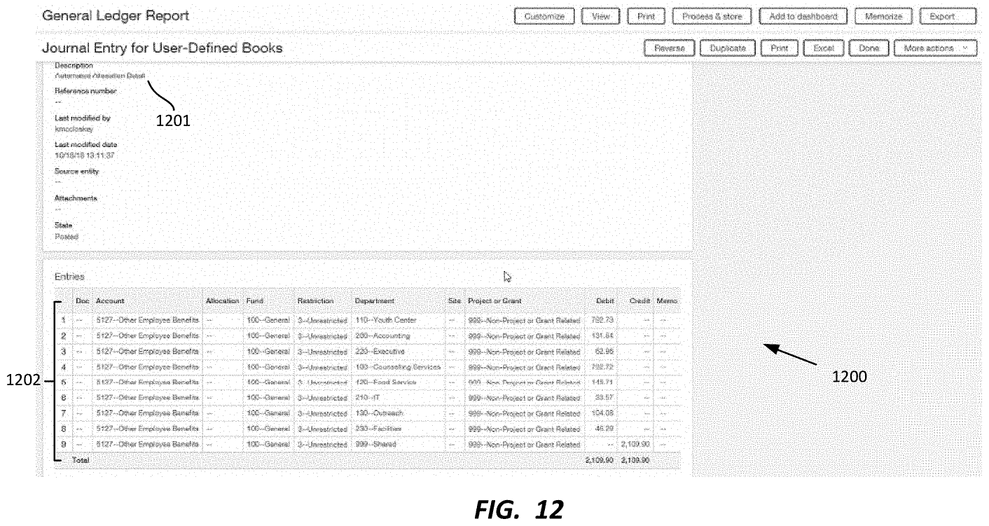

In at least one embodiment, user 100 can click on values shown in general ledger report 1110 to see more details. Referring now to FIG. 12, there is shown an example of journal entry report 1200 as may be displayed after user 100 clicks on value 1111. Journal entry report 1200 shows further details, including list 1202 of journal entries for a particular allocation.

In at least one embodiment, user 100 can click on automated allocation detail 1201 in general ledger report 1110 to see more details. Referring now to FIGS. 11C through 11E, there is shown an example of scrollable allocation information report 1130 as may be displayed after user 100 clicks on automated allocation detail 1201. Report 1130 provides a snapshot view of how the allocation was set up, including specifics of the calculations used. User 100 can click on See Source Pool Calculation 1131 to view the dollar amounts that went into the source pool calculation, or on See Basis Calculation 1132 to view the dollar amounts that went into the basis calculation, or he or she can click on See Dynamic Split Calculation 1133 to view how the split was derived.

### Source Pool Calculations

Source Pool Calculation link 1131 provides access to the calculations the system created based on the settings chosen for the source pool.

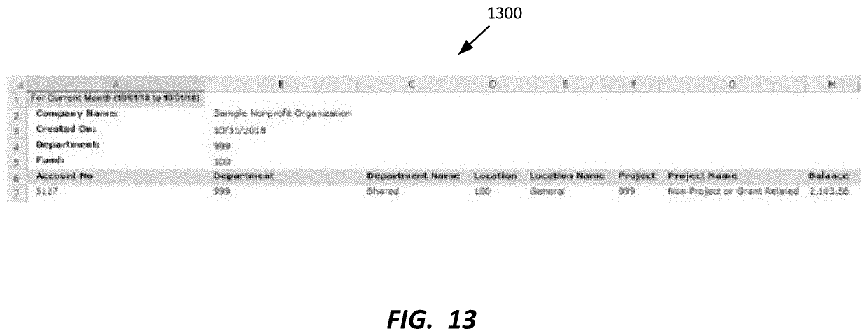

In at least one embodiment, link 1131 causes the system to display a spreadsheet document that contains the source pool information at the time the allocation was generated. Referring now to FIG. 13, there is shown an example 1300 of such a document containing source pool information. User 100 can review the source information for the allocation to confirm that the correct source was found.

### Basis Calculations

Basis Calculation link 1132 provides access to the calculations the system created based on the settings chosen for the basis of the allocation.

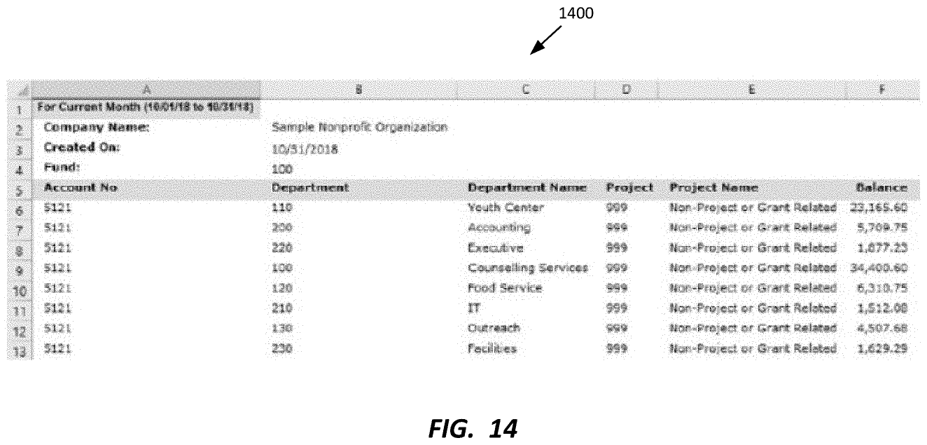

In at least one embodiment, link 1132 causes the system to display a spreadsheet document that contains the basis information at the time the allocation was generated. Referring now to FIG. 14, there is shown an example 1400 of such a document containing basis information. User 100 can review the basis calculations to determine if the settings for the basis returned the expected balances.

### Dynamic Split Calculations

Dynamic split calculations are percentages determined by the system based on the selected source, basis, and dimensions treatment settings. In at least one embodiment, these percentages are used to allocate the amount found in the source pool.

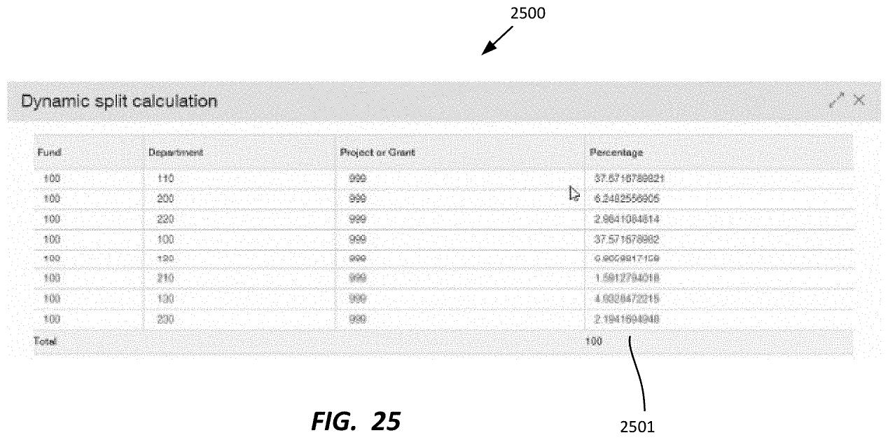

See Dynamic Split Calculation link 1133 provides access to calculations that indicate how the split was derived. A dialog box opens showing the percentages used by the system to allocate the amounts found in the source pool. Referring now to FIG. 25, there is shown an example of dynamic split calculation table 2500 for an allocation, according to one embodiment.

In at least one embodiment, the dynamic split is based on settings user 100 chose for how dimensions are treated, the source pool, and the basis. User 100 can review all these settings to verify that the dynamic split calculations match what is expected.

Once the allocation definition is set up, user 100 saves the definition and then generates an allocation based on this definition.

When an account allocation is generated, the system dynamically finds the source amount, applies the basis calculations in tandem with preservation of any dimension values, and returns an allocation entry. If the allocation is posted to a book specifically for allocations, a report showing the pre- and post-allocation activity levels can be generated.

### Example

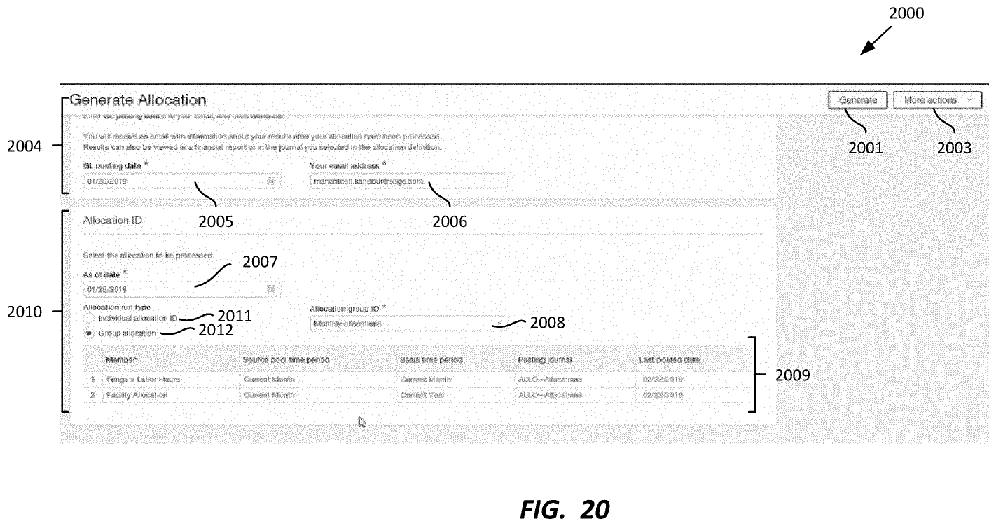

Referring now to FIG. 20, there is shown an example of a generate allocation screen 2000 according to one embodiment, including allocation parameters section 2004 and allocation ID section 2010.

In this example, the allocation is to be posted on Jan. 28, 2019; therefore, field 2005 indicates a GL posting date of Jan. 28, 2019. In at least one embodiment, allocations are processed offline. Accordingly, in field 2006, user 100 can provide his or her email address so as to be notified when the allocation has been generated.

Allocation ID section 2010 contains fields for specifying the allocation to be processed and the dates it should impact. In this example, the allocation is configured to impact activity in January; accordingly, field 2007 indicates that an “as of” date of Jan. 28, 2019.

User 100 can select an individual allocation ID by clicking on radio button 2011, or a group allocation by click on radio button 2012. In either case, a specific allocation ID or group ID can be selected from menu 2008.

In this example, user 100 has selected a group allocation with an ID of “Monthly allocations”. As shown, in response to user 100 selecting this allocation group, information about the members of the group is displayed in section 2009, to indicate the time periods and other information defined in allocations that are members of the group.

Once the allocation parameters have been specified, user 100 can click on Generate button 2001 to process the allocation. More actions menu 2003 provides access to additional features, including for example an option to cancel the allocation.

Once the allocation has been generated, user 100 can review it and verify that amounts have been moved in the expected way. One way to perform such review is to run a financial report. In at least one embodiment, user 100 can select among many different types of reports, such as for example a statement with expenses, to review a processed allocation.

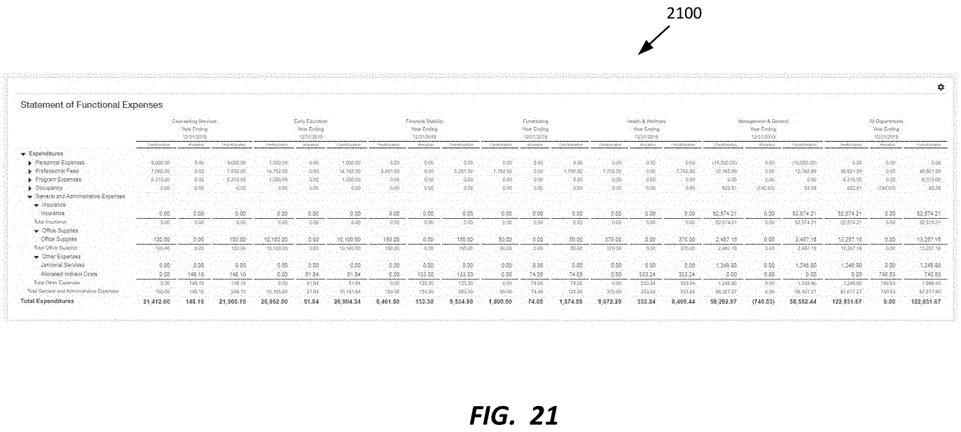

Referring now to FIG. 21, there is shown an example of a Statement of Functional Expenses 2100 that can be run from a financial report center of a software application, in order to verify an allocation. User 100 can check lines within statement 2100 for allocation amounts. Statement 2100 includes columns that display Pre-Allocation and Post-Allocation amounts, so that the user can see where amounts were moved.

Other review options may also be available. For example, if user 100 wants to review more than just the amounts moved during an allocation, as seen in a report, he or she can review the allocation in other ways, such as for example:
Review journal entries;
Review source pool calculations;
Review basis calculations; and
Review dynamic split calculations

### Allocation Journal Entry

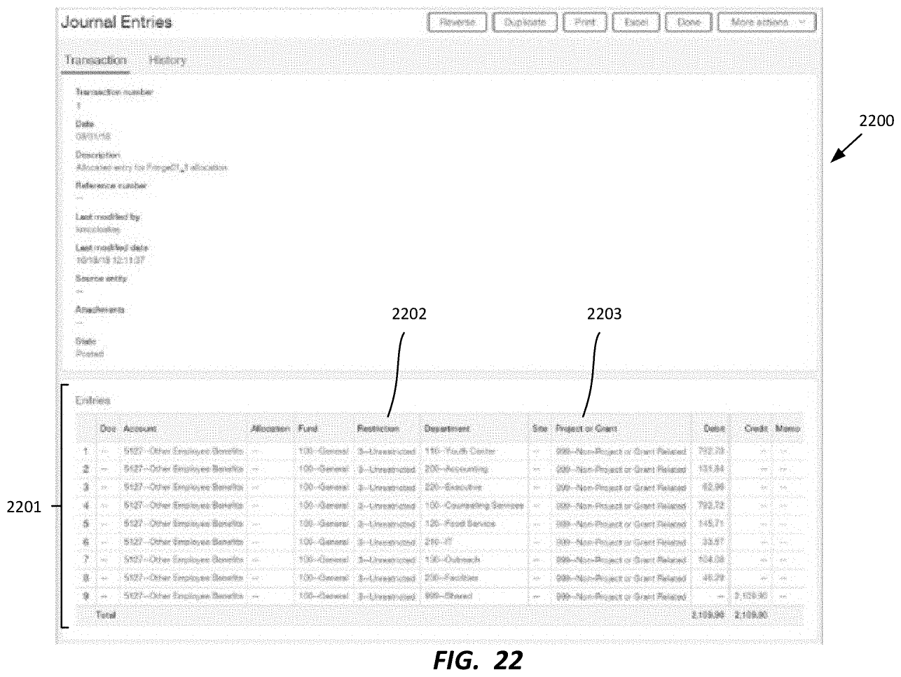

In at least one embodiment, user 100 can review the journal entry generated by the allocation. In the present example of the fringe allocation, user 100 navigates to the generated allocation to review the journal entry for the allocation. Once the journal entry for the account allocation opens, user 100 can review the journal entries for the allocation at the bottom of the page. Referring now to FIG. 22, there is shown an example of report 2200 including journal entries 2201. For each entry 2201, report 2200 shows an account, fund, restrictions, department, site, project or grant, debit amount, credit amount, and/or memo.

In at least one embodiment, some or all of the values shown in report 2200 may be drillable, meaning that user 100 can click on a value to see a snapshot of the data and calculations associated with that value. For example, in report 2200, values shown restrictions column 2202 and project or grant column 2203 may be drillable. In at least one embodiment, such drill-down functionality enables a snapshot look-back, or verification view, that allows user 100 to verify that the allocations were correctly applied.

### Source Pool Calculations

In at least one embodiment, user 100 can review the calculations the system created based on the settings chosen for the source pool.

In the present example of the fringe allocation, user 100 can navigate to the generated allocation to review the snapshot of the source pool at the time of allocation. Once the journal entry for the account allocation opens, user 100 can click a link under the Description heading. For the fringe allocation, this link is named Allocated entry for Fringe01_1 allocation. In at least one embodiment, this is an automatically generated name based on the number of times the allocation definition has been generated.

The Allocation Information page for the Fringe01 definition opens, showing information about who initiated the allocation, and when. In the Source pool section, user 100 can click the See Source Pool Calculation link. In at least one embodiment, this causes a spreadsheet document to be displayed, containing the source pool information at the time the allocation was run.

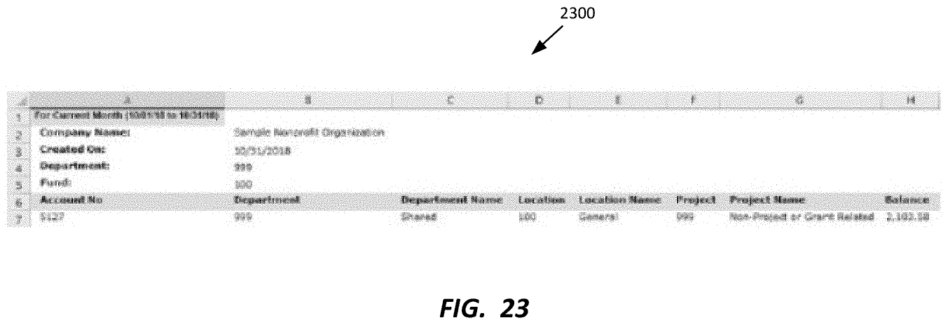

Referring now to FIG. 23, there is shown an example of spreadsheet document 2300, including the amounts the system found for the Fringe01 source pool, based on the dimensions treatment and the source pool parameters defined by user 100.

### Basis Calculations

In at least one embodiment, user 100 can review the calculations the system created based on the settings chosen for the basis.

In the present example of the fringe allocation, user 100 can navigate to the generated allocation to review the basis calculations at the time of allocation. Once the journal entry for the account allocation opens, user 100 can click a link under the Description heading. For the fringe allocation, this link is named Allocated entry for Fringe01_1 allocation. In at least one embodiment, this is an automatically generated name based on the number of times the allocation definition has been generated.

The Allocation Information page for the Fringe01 definition opens, showing information about who initiated the allocation, and when. In the Basis section, user 100 can click the See Basis Calculation link. In at least one embodiment, this causes a spreadsheet document to be displayed, containing the basis information at the time the allocation was generated.

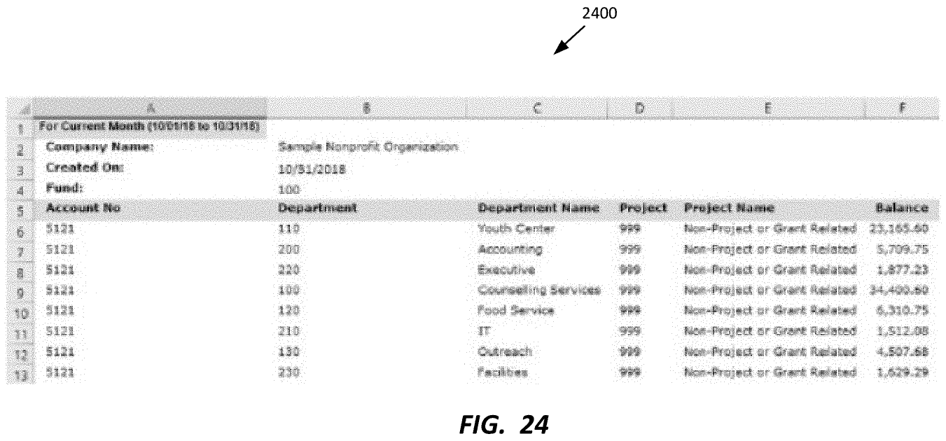

Referring now to FIG. 24, there is shown an example of spreadsheet document 2400, showing the amounts the system found for the Fringe01 basis, based on the dimensions treatment and the basis parameters defined by user 100.

### Dynamic Split Calculations

The dynamic split calculations are the percentage determined by the system based on the source, basis, and dimensions treatment settings. These percentages are used to allocate the amount found in the source pool. In at least one embodiment, user 100 can review these dynamic split calculations.

In the present example of the fringe allocation, user 100 can navigate to the generated allocation to review the dynamic split calculation created at the time of allocation. Once the journal entry for the account allocation opens, user 100 can click a link under the Description heading. For the fringe allocation, this link is named Allocated entry for Fringe01_1 allocation. In at least one embodiment, this is an automatically generated name based on the number of times the allocation definition has been generated.

The Allocation Information page for the Fringe01 definition opens, showing information about who initiated the allocation, and when. In the Target entry section, user 100 can click the See Dynamic Split Calculation link. Referring now to FIG. 25, there is shown an example 2500 of a dialog box that is then presented, including percentages 2501 used by the system to allocate the amounts found in the source pool. The dynamic split, as indicated by percentages 2501, is based on settings chosen for how dimensions are treated, the source pool, and the basis.

### Additional Functionality

In at least one embodiment, the system and method can include additional functionality related to dynamic account allocations, as follows:

### Allocate Asset and Liability Activity

In at least one embodiment, user 100 can allocate asset and liability account activity, such as accruals, as long as the account does not disallow direct posting. In this manner, user 100 can to allocate activity that is temporarily on the balance sheet so as to provide better insight as to the entity's true financial position.

### Import Dynamic Allocation Information

In at least one embodiment, user 100 can import allocation definitions, allocation groups and/or group member information. A template can be made available for download, allowing user 100 to populate setup information for an allocation that can then be imported into the system.

### Custom Reports on Allocation Information

In at least one embodiment, custom report writer functionality can be provided, allowing user 100 to generate custom reports on dynamic allocation information. The custom report writer can allow user 100 to use account allocation definitions, allocation groups, allocation group members, and/or allocation logs as primary data sources for reports.

In at least one embodiment, the custom report writer now contains the following dynamic account allocation objects:
GL Account Allocation
GL Account Allocation Basis
GL Account Allocation Reverse
GL Account Allocation Source
GL Account Allocation Target
Account Allocation Group Member
Account Allocation Groups

One skilled in the art will recognize that the examples depicted and described herein are merely illustrative, and that other arrangements of user interface elements can be used. In addition, some of the depicted elements can be omitted or changed, and additional elements depicted, without departing from the essential characteristics.

The present system and method have been described in particular detail with respect to possible embodiments. Those of skill in the art will appreciate that the system and method may be practiced in other embodiments. First, the particular naming of the components, capitalization of terms, the attributes, data structures, or any other programming or structural aspect is not mandatory or significant, and the mechanisms and/or features may have different names, formats, or protocols. Further, the system may be implemented via a combination of hardware and software, or entirely in hardware elements, or entirely in software elements. Also, the particular division of functionality between the various system components described herein is merely exemplary, and not mandatory; functions performed by a single system component may instead be performed by multiple components, and functions performed by multiple components may instead be performed by a single component.

Reference in the specification to “one embodiment” or to “an embodiment” means that a particular feature, structure, or characteristic described in connection with the embodiments is included in at least one embodiment. The appearances of the phrases “in one embodiment” or “in at least one embodiment” in various places in the specification are not necessarily all referring to the same embodiment.

Various embodiments may include any number of systems and/or methods for performing the above-described techniques, either singly or in any combination. Another embodiment includes a computer program product comprising a non-transitory computer-readable storage medium and computer program code, encoded on the medium, for causing a processor in a computing device or other electronic device to perform the above-described techniques.

Some portions of the above are presented in terms of algorithms and symbolic representations of operations on data bits within a memory of a computing device. These algorithmic descriptions and representations are the means used by those skilled in the data processing arts to most effectively convey the substance of their work to others skilled in the art. An algorithm is here, and generally, conceived to be a self-consistent sequence of steps (instructions) leading to a desired result. The steps are those requiring physical manipulations of physical quantities. Usually, though not necessarily, these quantities take the form of electrical, magnetic or optical signals capable of being stored, transferred, combined, compared and otherwise manipulated. It is convenient at times, principally for reasons of common usage, to refer to these signals as bits, values, elements, symbols, characters, terms, numbers, or the like. Furthermore, it is also convenient at times, to refer to certain arrangements of steps requiring physical manipulations of physical quantities as modules or code devices, without loss of generality.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “displaying” or “determining” or the like, refer to the action and processes of a computer system, or similar electronic computing module and/or device, that manipulates and transforms data represented as physical (electronic) quantities within the computer system memories or registers or other such information storage, transmission or display devices.

Certain aspects include process steps and instructions described herein in the form of an algorithm. It should be noted that the process steps and instructions can be embodied in software, firmware and/or hardware, and when embodied in software, can be downloaded to reside on and be operated from different platforms used by a variety of operating systems.

The present document also relates to an apparatus for performing the operations herein. This apparatus may be specially constructed for the required purposes, or it may comprise a general-purpose computing device selectively activated or reconfigured by a computer program stored in the computing device. Such a computer program may be stored in a computer readable storage medium, such as, but is not limited to, any type of disk including floppy disks, optical disks, CD-ROMs, DVD-ROMs, magnetic-optical disks, read-only memories (ROMs), random access memories (RAMs), EPROMs, EEPROMs, flash memory, solid state drives, magnetic or optical cards, application specific integrated circuits (ASICs), or any type of media suitable for storing electronic instructions, and each coupled to a computer system bus. Further, the computing devices referred to herein may include a single processor or may be architectures employing multiple processor designs for increased computing capability.

The algorithms and displays presented herein are not inherently related to any particular computing device, virtualized system, or other apparatus. Various general-purpose systems may also be used with programs in accordance with the teachings herein, or it may prove convenient to construct more specialized apparatus to perform the required method steps. The required structure for a variety of these systems will be apparent from the description provided herein. In addition, the system and method are not described with reference to any particular programming language. It will be appreciated that a variety of programming languages may be used to implement the teachings described herein, and any references above to specific languages are provided for disclosure of enablement and best mode.

Accordingly, various embodiments include software, hardware, and/or other elements for controlling a computer system, computing device, or other electronic device, or any combination or plurality thereof. Such an electronic device can include, for example, a processor, an input device (such as a keyboard, mouse, touchpad, track pad, joystick, trackball, microphone, and/or any combination thereof), an output device (such as a screen, speaker, and/or the like), memory, long-term storage (such as magnetic storage, optical storage, and/or the like), and/or network connectivity, according to techniques that are well known in the art. Such an electronic device may be portable or nonportable. Examples of electronic devices that may be used for implementing the described system and method include: a mobile phone, personal digital assistant, smartphone, kiosk, server computer, enterprise computing device, desktop computer, laptop computer, tablet computer, consumer electronic device, or the like. An electronic device may use any operating system such as, for example and without limitation: Linux; Microsoft Windows, available from Microsoft Corporation of Redmond, Wash.; Mac OS X, available from Apple Inc. of Cupertino, Calif.; iOS, available from Apple Inc. of Cupertino, Calif.; Android, available from Google, Inc. of Mountain View, Calif.; and/or any other operating system that is adapted for use on the device.

While a limited number of embodiments have been described herein, those skilled in the art, having benefit of the above description, will appreciate that other embodiments may be devised. In addition, it should be noted that the language used in the specification has been principally selected for readability and instructional purposes, and may not have been selected to delineate or circumscribe the subject matter. Accordingly, the disclosure is intended to be illustrative, but not limiting, of scope.

What is claimed is:

1. A computer-implemented method for specifying, viewing, and verifying accounting allocations, comprising:
at an input device, receiving user input specifying at least one allocation;
at a hardware processor communicatively coupled to the input device, applying the specified at least one allocation to at least one account;
at a storage device communicatively coupled to the hardware processor, storing a record representing the application of the specified at least one allocation to the at least one account; and
at an output device, displaying output verifying the application of the at least one allocation to the at least one account.

2. The method of claim 1, further comprising:
at the input device, receiving user input specifying a justification for the least one allocation;
at the storage device, storing a representation of the specified justification;
at the output device, providing access to a snapshot look-back function to provide views of previously specified justifications for allocations;
at the input device, receiving user input activating the snapshot look-back function; and
responsive to receiving the user input activating the snapshot look-back function, displaying, at the output device, a report indicating at least one previously specified justification for at least one allocation.

3. The method of claim 1, further comprising:
at the input device, receiving user input activating a before/after comparison report function; and
responsive to receiving the user input activating the before/after comparison report function, displaying, at the output device, a report comparing the status of at least one account before and after application of the at least one allocation.

4. The method of claim 3, wherein the report depicts the effect of the at least one allocation on the at least one account.

5. The method of claim 1, further comprising:
at the input device, receiving user input activating a historical allocation report function; and
responsive to receiving the user input activating the historical allocation report function, displaying, at the output device, a report indicating a history of a plurality of allocations for an account at different points in time.

6. The method of claim 1, wherein receiving user input specifying at least one allocation comprises, for each allocation, performing at least one selected from the group consisting of:
receiving user input specifying a source of the allocation;
receiving user input specifying a basis of the allocation; and
receiving user input specifying a target of the allocation.

7. The method of claim 1, wherein:
receiving user input specifying at least one allocation comprises, for each allocation, receiving user input specifying a rationale for the allocation; and
storing a record representing the application of the specified at least one allocation to the at least one account comprises, for each allocation, storing the specified rationale for the allocation.

8. The method of claim 1, wherein:
receiving user input specifying at least one allocation comprises receiving user input specifying an allocation group comprising a plurality of allocations; and
storing a record representing the application of the specified at least one allocation to the at least one account comprises storing a record representing the application of each allocation in the specified group to the at least one account.

9. The method of claim 8, further comprising, prior to receiving user input specifying at least one allocation:
receiving user input defining the allocation group; and
storing a record representing the application group, including a list of allocations in the allocation group.

10. The method of claim 1, further comprising sending a notification to confirm successful application of the specified at least one allocation.

11. The method of claim 1, wherein the specified allocation is automatically generated.

12. A non-transitory computer-readable medium for specifying, viewing, and verifying accounting allocations, comprising instructions stored thereon, that when performed by a hardware processor, perform the steps of:
causing an input device to receive user input specifying at least one allocation;
applying the specified at least one allocation to at least one account;
causing a storage device to store a record representing the application of the specified at least one allocation to the at least one account; and
causing an output device to display output verifying the application of the at least one allocation to the at least one account.

13. The non-transitory computer-readable medium of claim 12, further comprising:
causing the input device to receive user input specifying a justification for the least one allocation;
causing the storage device to store a representation of the specified justification;
causing the output device to provide access to a snapshot look-back function to provide views of previously specified justifications for allocations;
causing the input device to receive user input activating the snapshot look-back function; and
responsive to receiving the user input activating the snapshot look-back function, causing the output device to display a report indicating at least one previously specified justification for at least one allocation.

14. The non-transitory computer-readable medium of claim 12, further comprising:
causing the input device to receive user input activating a before/after comparison report function; and
responsive to the input device receiving the user input activating the before/after comparison report function, causing the output device to display a report comparing the status of at least one account before and after application of the at least one allocation.

15. The non-transitory computer-readable medium of claim 14, wherein the report depicts the effect of the at least one allocation on the at least one account.

16. The non-transitory computer-readable medium of claim 12, further comprising:
causing the input device to receive user input activating a historical allocation report function; and
responsive to receiving the user input activating the historical allocation report function, causing the output device to display a report indicating a history of a plurality of allocations for an account at different points in time.

17. The non-transitory computer-readable medium of claim 12, wherein causing the input device to receive user input specifying at least one allocation comprises, for each allocation, performing at least one selected from the group consisting of:
causing the input device to receive user input specifying a source of the allocation;
causing the input device to receive user input specifying a basis of the allocation; and
causing the input device to receive user input specifying a target of the allocation.

18. The non-transitory computer-readable medium of claim 12, wherein:
causing the input device to receive user input specifying at least one allocation comprises, for each allocation, causing the input device to receive user input specifying a rationale for the allocation; and
causing the storage device to store a record representing the application of the specified at least one allocation to the at least one account comprises, for each allocation, causing the storage device to store the specified rationale for the allocation.

19. The non-transitory computer-readable medium of claim 12, wherein:
causing the input device to receive user input specifying at least one allocation comprises causing the input device to receive user input specifying an allocation group comprising a plurality of allocations; and
causing the storage device to store a record representing the application of the specified at least one allocation to the at least one account comprises causing the storage device to store a record representing the application of each allocation in the specified group to the at least one account.

20. The non-transitory computer-readable medium of claim 19, further comprising, prior to receiving user input specifying at least one allocation:
causing the input device to receive user input defining the allocation group; and
causing the storage device to store a record representing the application group, including a list of allocations in the allocation group.

21. The non-transitory computer-readable medium of claim 12, further comprising sending a notification to confirm successful application of the specified at least one allocation.

22. The non-transitory computer-readable medium of claim 12, wherein the specified allocation is automatically generated.

23. A system for specifying, viewing, and verifying accounting allocations, comprising:
an input device configured to receive user input specifying at least one allocation;
a hardware processor communicatively coupled to the input device, configured to apply the specified at least one allocation to at least one account;
a storage device communicatively coupled to the hardware processor, configured to store a record representing the application of the specified at least one allocation to the at least one account; and
an output device communicatively coupled to the hardware processor, configured to display output verifying the application of the at least one allocation to the at least one account.

24. The system of claim 23, wherein:
the input device is further configured to receive user input specifying a justification for the least one allocation;
the storage device is further configured to store a representation of the specified justification;
the output device is further configured to provide access to a snapshot look-back function to provide views of previously specified justifications for allocations;
the input device is further configured to receive user input activating the snapshot look-back function; and
the output device is further configured to, responsive to the input device receiving the user input activating the snapshot look-back function, display a report indicating at least one previously specified justification for at least one allocation.

25. The system of claim 23, wherein:
the input device is further configured to receive user input activating a before/after comparison report function; and
the output device is further configured to, responsive to the input device receiving the user input activating the before/after comparison report function, display a report comparing the status of at least one account before and after application of the at least one allocation.

26. The system of claim 25, wherein the report depicts the effect of the at least one allocation on the at least one account.

27. The system of claim 23, wherein:
the input device is further configured to receive user input activating a historical allocation report function; and
the output device is further configured to, responsive to the input device receiving the user input activating the historical allocation report function, display a report indicating a history of a plurality of allocations for an account at different points in time.

28. The system of claim 23, wherein receiving user input specifying at least one allocation comprises, for each allocation, performing at least one selected from the group consisting of:
receiving user input specifying a source of the allocation;
receiving user input specifying a basis of the allocation; and
receiving user input specifying a target of the allocation.

29. The system of claim 23, wherein:
receiving user input specifying at least one allocation comprises, for each allocation, receiving user input specifying a rationale for the allocation; and
storing a record representing the application of the specified at least one allocation to the at least one account comprises, for each allocation, storing the specified rationale for the allocation.

30. The system of claim 23, wherein:
receiving user input specifying at least one allocation comprises receiving user input specifying an allocation group comprising a plurality of allocations; and
storing a record representing the application of the specified at least one allocation to the at least one account comprises storing a record representing the application of each allocation in the specified group to the at least one account.

31. The system of claim 30, wherein:
the input device is further configured to, prior to receiving user input specifying at least one allocation, receive user input defining the allocation group; and
the storage device is further configured to store a record representing the application group, including a list of allocations in the allocation group.

32. The system of claim 23, further comprising a notification transmission mechanism communicatively coupled to the hardware processor, configured to send a notification to confirm successful application of the specified at least one allocation.

33. The system of claim 23, wherein the specified allocation is automatically generated.
